(19) United States
(12) Patent Application Publication
(10) Pub. No.: US 2014/0311828 A1
(43) Pub. Date: Oct. 23, 2014

(54) MODULAR TREE-MOUNTABLE HUNTING STAND

(71) Applicants: Irwin Jay Bassett, Pierson, MI (US); Kevin Bassett, Grand Rapids, MI (US)

(72) Inventors: Irwin Jay Bassett, Pierson, MI (US); Kevin Bassett, Grand Rapids, MI (US)

(21) Appl. No.: 14/319,102

(22) Filed: Jun. 30, 2014

Related U.S. Application Data
(63) Continuation-in-part of application No. 13/678,480, filed on Nov. 15, 2012.

(51) Int. Cl. A01M 31/02; E06C 7/00

(52) U.S. Cl. CPC A01M 31/02; E06C 7/00
USPC 182/124

(57) ABSTRACT

A support frame rail with a central longitudinal axis is orthogonally coupled with a pivot beam. A support frame plate slidably couplable with the support frame rail includes an embedment projection. A hanger plate is fixable couplable with the support frame rail. A planar support platform is pivotably coupleable with the pivot beam. A saddle has a pommel portion, a saddle support portion, and a connecting straddle portion. A saddle bearing assembly defines a first rotation axis and is rotatably coupled with the saddle. A support frame bearing assembly defines a second rotation axis collinear with the central longitudinal axis. A pivot arm assembly is rigidly coupled with the saddle bearing assembly and the support frame bearing assembly. The straddle portion has a triangular cross-section, and enables adoption of an unsupported standing position, a partially supported standing position, or a weight-forward standing position, by a hunter straddling the straddle portion.

### CROSS-REFERENCE TO RELATED APPLICATIONS

This application is a continuation-in-part of U.S. application Ser. No. 13/678,480, filed Nov. 15, 2012, which is incorporated by reference herein in its entirety.

### BACKGROUND

### Brief Description of the Invention

A support frame rail with a central longitudinal axis is orthogonally coupled with a pivot beam. A support frame plate slidably couplable with the support frame rail includes an embedment projection. A hanger plate is fixable couplable with the support frame rail. A planar support platform is pivotably coupleable with the pivot beam. A saddle has a pommel portion, a saddle support portion, and a connecting straddle portion. A saddle bearing assembly defines a first rotation axis and is rotatably coupled with the saddle. A support frame bearing assembly defines a second rotation axis collinear with the central longitudinal axis. A pivot arm assembly is rigidly coupled with the saddle bearing assembly and the support frame bearing assembly. The straddle portion has a triangular cross-section, and enables adoption of an unsupported standing position, a partially supported standing position, or a weight-forward standing position, by a hunter straddling the straddle portion.

### BRIEF DESCRIPTION OF THE DRAWINGS

In the drawings:

FIG. 1 is a side view of a tree-mountable hunting stand according to an embodiment of the invention, including a support frame, a first embodiment saddle assembly, and a platform assembly.

FIG. 2 is a perspective view of the support frame illustrated in FIG. 1 attached to a tree, with the saddle assembly and platform assembly removed for purposes of clarity.

FIG. 3 is a front elevation view of the support frame and platform assembly, with the saddle assembly removed for clarity.

FIG. 4 is a plan view from above of the platform assembly and support frame, with the saddle assembly shown in a schematic partially phantom view.

FIG. 5 is a schematic side view of the support frame and platform assembly, with an exemplary platform support assembly.

FIGS. 6A-D are perspective views of several embodiments of the hanger plate adapted for several functionalities, including a seat functionality.

FIGS. 7A and B are perspective views of alternative embodiments of the saddle illustrated in FIGS. 6A and B.

FIG. 8 is a perspective view of a gun rest assembly that can pivot from an upright position to a horizontal position, supported by a hanger plate.

FIG. 9 is a rear elevation view of the tree-mountable hunting stand according to a second embodiment of the invention, including a support frame assembly, a second embodiment saddle assembly, and a platform assembly.

FIG. 10 is a side perspective view of the tree-mountable hunting stand illustrated in FIG. 9 attached to a tree.

FIG. 11 is a plan view of a hanger plate comprising part of the support frame illustrated in FIGS. 9 and 10.

FIG. 12 is a plan view of a support frame plate comprising part of the support frame illustrated in FIGS. 9 and 10.

FIG. 13 is an enlarged perspective view of coupled portions of the platform assembly and frame assembly illustrated in FIG. 9, including a portion of a ligature assembly.

FIG. 14 is a side perspective view of the second embodiment saddle assembly and a portion of the support frame assembly illustrated in FIGS. 9 and 10.

FIGS. 15A and 15B are a side elevation view and a perspective view, respectively, of a saddle illustrated in FIG. 14.

FIG. 16 is a downward perspective view of the platform assembly and a portion of the support frame assembly illustrated in FIGS. 9 and 10.

FIG. 17 is an enlarged side perspective view of the platform assembly and portion of the support frame assembly illustrated in FIG. 16, showing a pivot connection.

FIG. 18 is a side elevation view of a platform pivot bracket comprising part of the platform assembly illustrated in FIG. 17.

FIG. 19 is a side elevation view of a cable block platform suspension fixture comprising part of the platform assembly illustrated in FIG. 16.

FIGS. 20A and 20B illustrate a side elevation view and a top plan view, respectively, of a threaded climbing anchor illustrated in FIG. 10 for insertion into a tree and support of the tree-mountable hunting stand thereon.

FIG. 21 is an alternative embodiment of the support frame plate comprising a circular support frame rail opening, an elongate ligature through opening, and a plurality of teeth.

### DETAILED DESCRIPTION OF THE INVENTION

The invention relates to elevated assemblies for supporting a user at a selected elevation. The invention is described and illustrated herein in the context of a tree-mountable hunting stand for supporting a hunter using a firearm, a compound bow, a crossbow, and the like. Alternatively, the invention may be utilized for other activities, e.g. wildlife viewing, photography, biological research, and the like, with little or no modification from the description and illustrations herein. For purposes of description related to the Figures, the terms “upright,” “upper,” “lower,” “right,” “left,” “rear,” “front,” “vertical,” “horizontal,” and derivatives thereof shall relate to the invention as oriented from the perspective of a user with the user's back against a tree to which the hunting stand is attached, as described herein. However, it may be understood that the invention may assume various alternative orientations, except where expressly specified to the contrary.

The specific devices and dynamics illustrated in the attached drawings, and described in the following specification, are merely exemplary embodiments of the inventive concepts defined in the appended claims. Hence, specific configurations, dimensions, and other physical characteristics relating to the embodiments disclosed herein are merely examples, and are not to be considered as limiting, unless the claims expressly state otherwise. Moreover, it is to be understood that the structural elements of the invention illustrated in the attached drawings, and described in the following specification, may be fabricated of alternative materials, and no single material shall be considered as limiting, unless expressly stated otherwise. Unless otherwise expressed, any material utilized for an element of the invention is to be understood as having properties, such as strength, durability, flexibility, and the like, that are suitable for the purposes intended. As well, unless otherwise expressed, “rigidly coupled,” “rigidly connected,” and like terms, may include welded couplings, brazed couplings, keyed couplings, threaded and unthreaded couplings, and any other fastening method providing a rigid joint between two members.

Finally, the hunting stands disclosed herein may be attached to a tree, as may generally be the custom. Nevertheless, the hunting stands may be attached to alternative vertical members, such as poles, or other suitable artificial structures. For brevity and convenience, the term “tree” will be used herein to refer to trees, poles, and suitable alternative members, unless expressly stated otherwise. Construction of the term “tree” as used herein is without limitations as to height, diameter, girth, species, or any other characteristic or condition, except where expressly stated to the contrary.

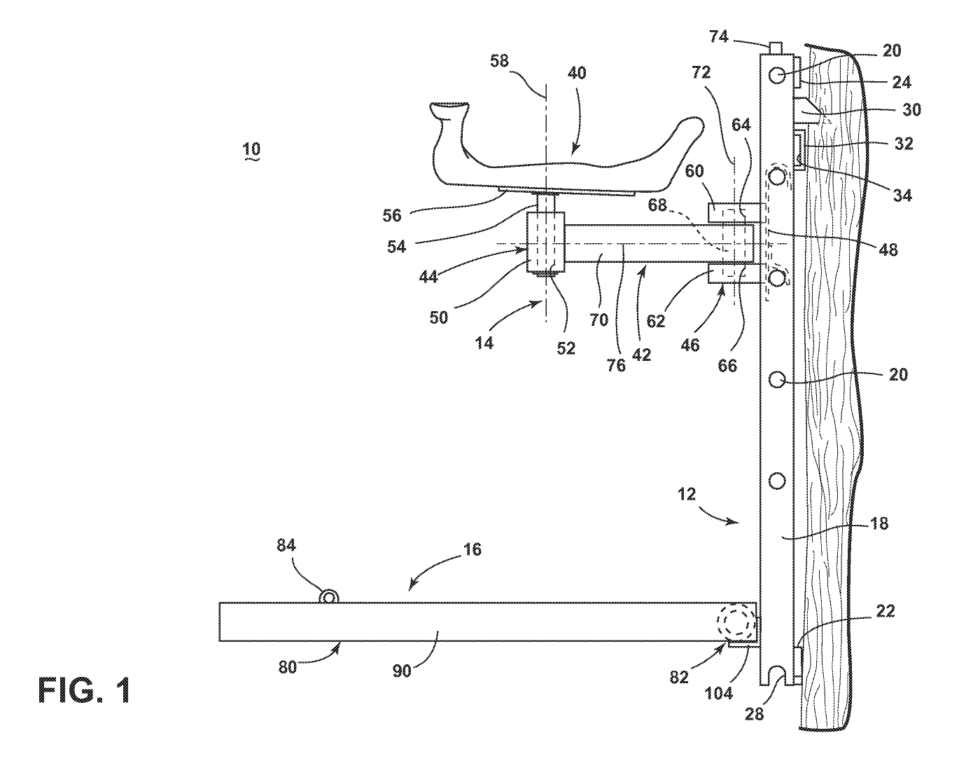

Referring to the drawings and particularly to FIG. 1, a tree-mountable hunting stand 10 may be a modular assembly that may include a support frame 12, a platform assembly 16 pivotably coupled with the support frame 12, and at least one of a hanger plate assembly and a saddle assembly 14, according to an embodiment of the invention. As will be described hereinafter, the support frame 12 may be fastened to a tree, the platform 16 may be pivoted to a horizontal orientation, and the saddle assembly 14 may be removably coupled with the support frame 12 to enable a hunter to readily configure the hunting stand 10 against or on a tree.

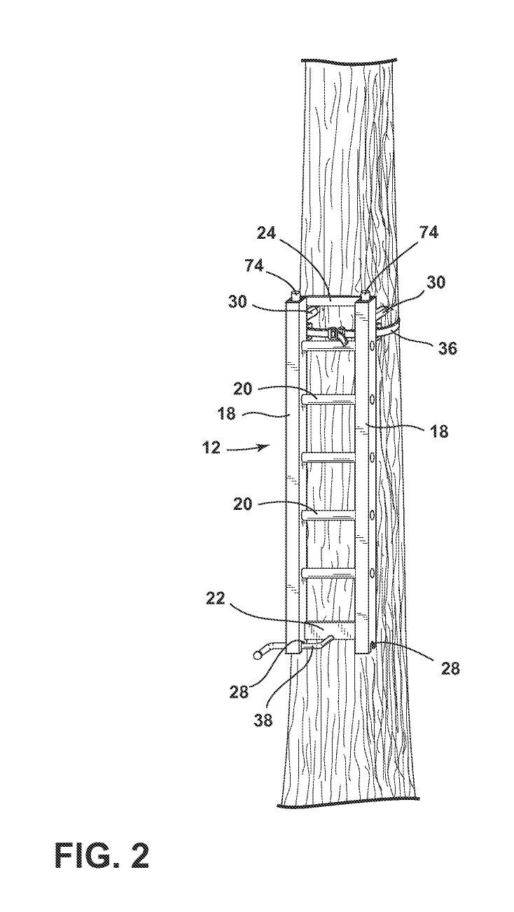

Referring also to FIG. 2, the support frame 12 may be a ladder-like body having a pair of spaced parallel vertical support members, also referred to as frame rails 18, and a plurality of horizontal support members, also referred to as rungs 2, rigidly attached to and extending between the frame rails 18. The frame rails 18 may be hollow or solid elongate members. Each frame rail 18 may terminate at the top in an extension coupler 74 (illustrated as a cylindrical peg) adapted for longitudinally joining support frames 12 through seating of each extension coupler 74 in a complementary recess (not shown) in the bottom ends of an adjoining frame rail 18.

The support frame 12 may include a lower tie beam 22 and an upper tie beam 24 rigidly coupling the frame rails 18 to provide resistance to “racking” of the frame 12. A semi-circular opening 26 may extend inwardly from a lower edge of the lower tie beam 22 for engagement with a known crank-type threaded climbing step 38 driven into a tree. A semi-circular opening 28 may extend inwardly from a lower edge of each frame rail 18 for engagement with the climbing step 38.

A frame anchor 30 including a beveled end portion for penetration into a tree may be rigidly attached to an upper portion of each frame rail 18. Each frame rails 18 may also have a hanger loop 32 through which an attachment ligature 36 may be inserted for attaching the support frame 12 to a tree. The attachment ligature 36 may be a known ligature, such as a strap, a chain, a rope, or other similar implement.

The saddle assembly 14 may be generally a hanger plate assembly, and may include a saddle 40 for supporting a hunter in a seated or almost standing position, a hanger plate 48, and a pivot arm 42 coupling the saddle 40 with the hanger plate 48. The pivot arm 42 may be an elongate member adapted for cantilevered support of the saddle 40 and hunter. The pivot arm 42 may include a cantilevered beam 70 defining a longitudinal axis 76, and may terminate at a first end in a saddle connection 44 and at a second end in a pivot pin 68. The hanger plate 48 with attached seat assembly 14 may be selectively suspended from at least one rung of the support frame 12 to accommodate hunters of differing heights with differing seating preferences.

The hanger plate 48 may have a generally planar plate-like hanger plate body 130 transitioning at a top edge to a U-shaped fold-over suspension hook 132. The suspension hook 132 may be configured to slidably receive a rung 20 therein, thereby suspending the hanger plate 48 vertically against the rungs of the support frame 12. A supplemental suspension hook 134 may be rigidly attached to the hanger plate body 130 beneath the suspension hook 132 a distance enabling the suspension hook 132 and supplemental suspension hook 134 to be concurrently hung from vertically separate rungs.

A saddle support plate 56 may be a generally plate-like body adapted for attachment to the underside of the saddle 40, such as with screws, rivets, adhesives, and the like. A pivot spindle 54 may be rigidly attached to the saddle support plate 56 to extend orthogonally away from the plate 56. The spindle 54 may be rigidly attached to the plate 56 by suitable means, such as welding, buttressing, keyed coupling, a combination of methods, and the like.

The saddle connection 44 may include a pivot bearing block 50 rigidly coupled with a first end of the cantilevered beam 70. The pivot bearing block 50 may be a cuboid or cylindrical body having a spindle opening 52 extending therethrough orthogonal to the longitudinal axis 76 of the cantilevered beam 70. The spindle opening 52 may slidably receive the pivot spindle 54. The saddle 40 may rotate about the rotation axis 58 concentric with the spindle opening 52 and pivot spindle 54.

To facilitate rotation of the saddle 40, and to minimize sound that may result from friction between the rotating pivot spindle 54 and the spindle opening 52, a low-friction annular bearing (not shown) may be seated in the spindle opening 52. The bearing may be fabricated of a low-friction material, such as Delrin®, nylon, and the like. The bearing may have an outer diameter somewhat smaller than the inner diameter of the spindle opening 52 so that the bearing may be inserted into the spindle opening 52 and frictionally retained therein.

The low-friction bearing may have an inner diameter somewhat larger than the diameter of the pivot spindle 54 so that the pivot spindle 54 may be slidably inserted into the bearing. The saddle 40 may be rotated relative to the pivot bearing block 50 with little generation of noise.

The pivot arm connection 46 may enable the cantilevered beam 70 to rotate about a rotation axis 72. The pivot arm connection 46 may include an upper pivot bearing 60 and a lower pivot bearing 62, each fabricated of a material having selected properties, such as steel, aluminum, and the like.

The upper pivot bearing 60 may be a somewhat plate-like body having a circular upper pivot recess 64 extending into the upper pivot bearing 60. The lower pivot bearing 62 may be a plate-like body having a circular lower pivot recess 66 extending into the lower pivot bearing 62. Alternatively, the pivot recesses 64, 66 may each extend through the pivot bearings 60, 62, respectively, to form through openings for receipt of the opposed elongated ends of the pivot pin 68. The pivot bearings 60, 62 may have identical configurations, or different configurations; e.g. the lower pivot bearing 62 may have a somewhat greater area relative to the upper pivot bearing 60 to enhance support of the pivot arm 42 over the range of rotating movement.

The pivot bearings 60, 62 may be rigidly attached to the hanger plate 48 with the upper and lower pivot recesses 64, 66 concentrically disposed to accommodate the cantilevered beam 70 therebetween. The pivot pin 68 may be seated in the upper and lower pivot recesses 64, 66 for rotation about the rotational axis 72. Each pivot recess 64, 66 may be lined with a low-friction bearing or sleeve (not shown) configured to accommodate the pivot pin 68 for silent rotation of the cantilevered beam 70 about the rotation axis 72. The facing surfaces of the upper and lower pivot bearings 60, 62 may also have a low-friction bearing liner (not shown) to minimize sound from rubbing movement of the cantilevered beam 70 against the pivot bearings 60, 62.

Referring to FIGS. 1, 3, and 4, the platform assembly 16 may include a platform 80 and a pivot connection 82. The platform 80 may be a somewhat semicircular-shaped open frame 86 comprising elongate frame members 88 and a perimetric member 90 defining an arcuate outer edge. The platform frame 86 may be fabricated of structural members, such as structural tubing, angle iron, I-beam members, and the like, which may be fabricated of steel, aluminum, and the like.

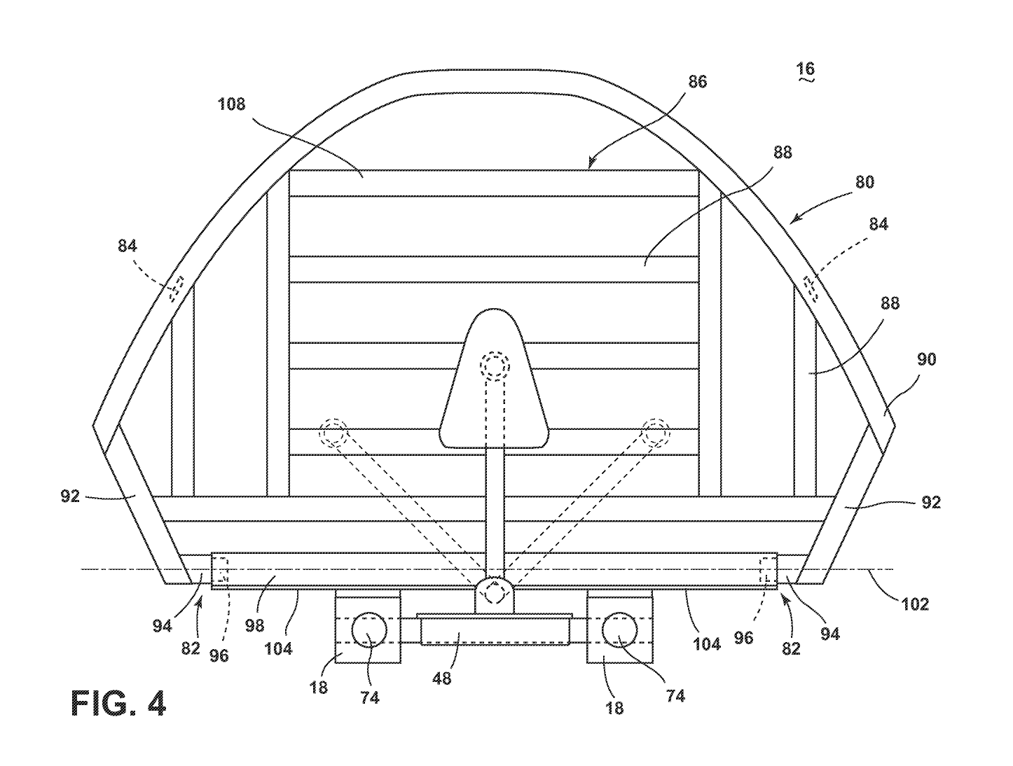

The frame members 88 may be rigidly coupled into a generally rectangular frame 86 having sufficient strength for supporting a hunter and equipment. The perimetric member 90 may be rigidly attached to the platform frame 86 to define the platform 80. The perimetric member 90 may terminate at each end in a pivot block 94 forming part of the pivot connection 82. It should be understood that the platform framework of FIG. 4 is merely exemplary, and may have configurations different than that illustrated. The size and configuration of the platform 80 may be adapted to the arcuate sweep of the saddle 40 and cantilevered beam 70.

Referring to FIGS. 1 and 4, each pivot connection 82 may comprise an integral pivot block 94 and pivot pin 96. Each pivot block 94 may be rigidly coupled with an end of the perimetric member 90, and each pivot pin 96 may be slidably inserted into the end of a hollow pivot beam 98. The opening at each end of the pivot beam 98 may be lined with a low-friction sleeve (not shown) to slidably receive the pivot pin 96 for silent pivoting of the platform 80 about a horizontal axis 102.

The pivot beam 98 may be an elongate hollow member having a rectangular or circular cross-section, and defining a longitudinal axis 102. The pivot beam 98 may be rigidly attached to a support member 104, such as an angle iron. The support member 104 may be rigidly coupled with the frame rails 18 so that the support member 104 and pivot beam 98 may be oriented orthogonal to the support frame 12.

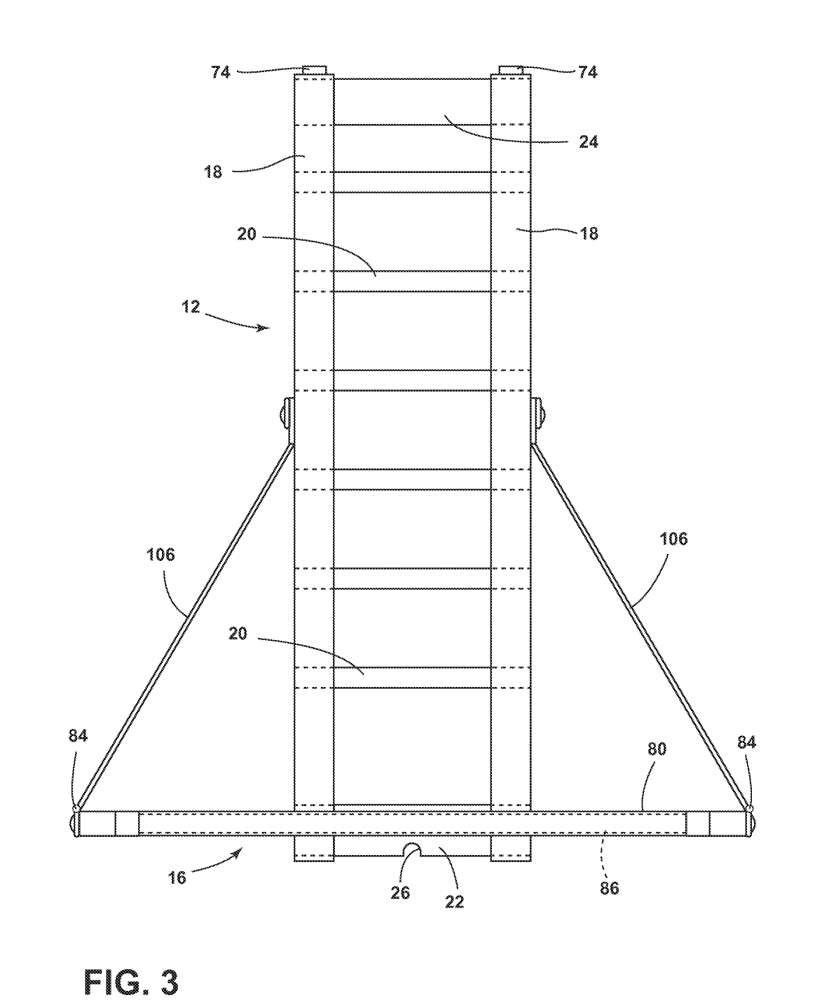

Referring again to FIG. 3, the platform 80 may be stabilized relative to the support frame 12 by a pair of anti-tilt members 106. The anti-tilt members 106 may be coupled with the frame rails 18 along an outer side thereof, and also coupled with the platform 80 through a tilt coupling 84. The anti-tilt members 106 may be flexible, such as steel cable, or solid, such as steel rods. The coupling 84 may be an eyelet rigidly coupled with the perimetric member 90. A cable may be attached to the eyelet 84 in a known manner, such as with a hook, a carabiner, a ring, and the like. The flexibility of the cable may enable the platform 80 to rotate upwardly about the horizontal axis 102 without disconnecting the cable from the eyelet 84.

The rod may include a mechanism, such as a spring snap, a trigger snap, and the like, enabling disconnection of the rod from the tilt coupling 84. With the rod free of the platform 80, the platform 80 may be rotated about the horizontal axis 102.

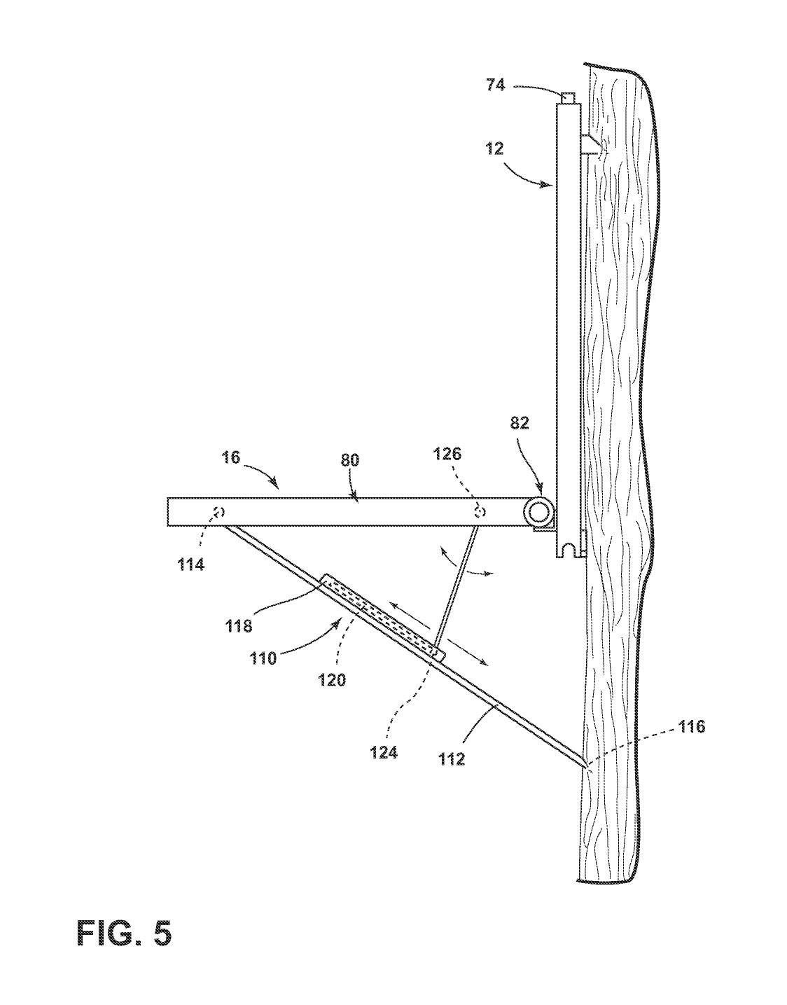

Alternatively, the platform 80 may be supported from the underside through a cantilever brace assembly 110 (FIG. 5). The brace assembly 110 may comprise an elongate compression member 112 attached at a first end to a pivot connection 114 attached at a forward portion, such as a cross-member 108 (FIG. 4), of the platform 80. The second end of the compression member 112 may terminate in a tapered end 116 for insertion into a tree to facilitate orienting the platform 80 in a horizontal position.

An elongate tension member 122 may be coupled at one end through a pivot connection 126 attached to the platform 80, and at an opposed end to the compression member 112 through a channelway pin 124. A channelway member 118 may be integrated with the compression member 112, and may have a channelway 124 accommodating the channelway pin 124 in slidable disposition. Movement of the channelway pin 124 in the channelway 120 may enable pivotal movement of the compression member 112, thus facilitating placement of the tapered end 116 and leveling of the platform 80.

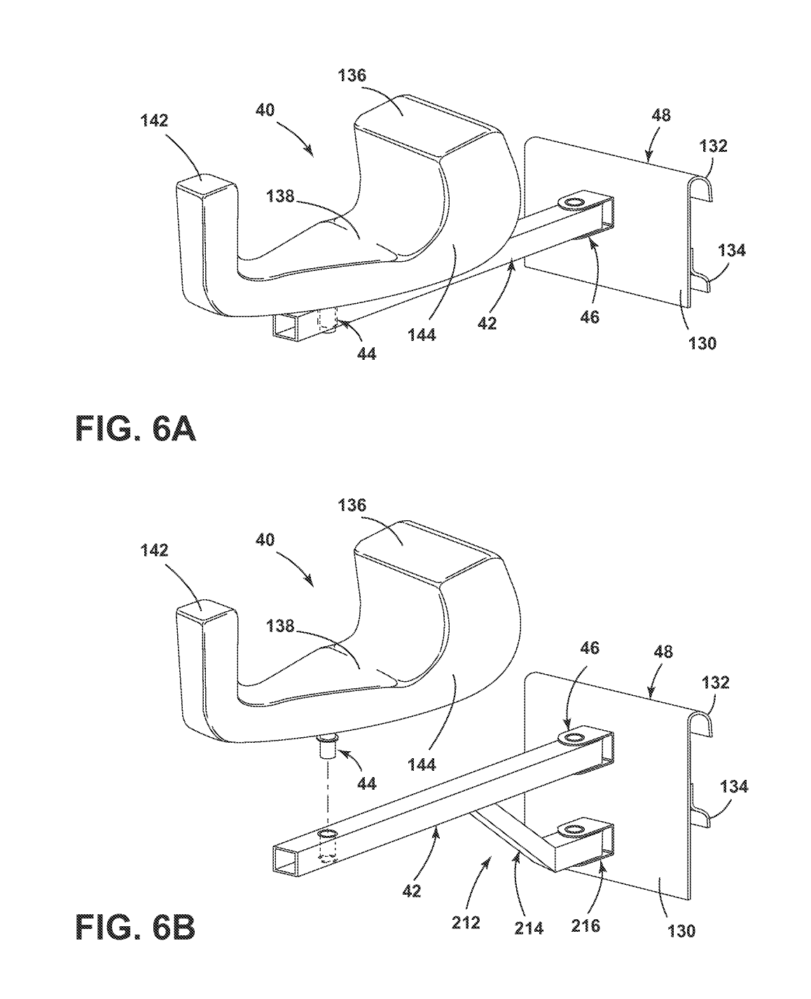

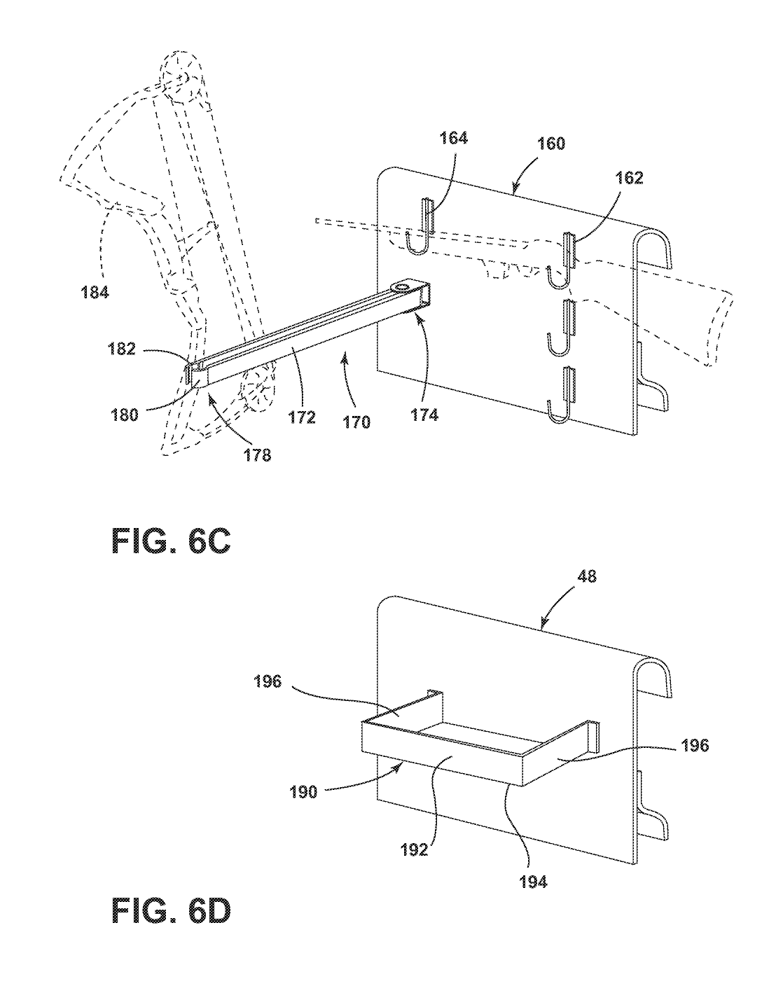

Referring to FIGS. 6A and B, the saddle 40 may have an irregularly-shaped, bilaterally symmetrical body comprising a saddle back 136 transitioning to a seat surface 138, in turn transitioning to an upwardly extending pommel 142. The saddle back 136 may have a height and width providing individualized comfort, support, and stability for individual hunters. The saddle 40 may include saddle sides 144 traversing from the top of the saddle back 136 to the top of the pommel 142. The saddle sides 144 may transition from the saddle back 136 to the pommel 142 through a gradual inward progression. The pommel 142 may be a column-like portion of the saddle 40 having a generally rectangular cross-section.

When a hunter is utilizing the saddle 40, the saddle 40 may be positioned so that the vertical movement of a hunter from a fully seated position to a standing position may be relatively minimal. The pommel 142 may provide a hunter with an enhanced degree of balance, positioning, and stability while aiming at a target. The saddle 40 and saddle connection 44 may be configured to optimize the balance of the saddle 40 relative to the pivot arm 42, thereby optimizing the rotational stability of the saddle 40 and hunter.

FIG. 6B illustrates an alternate embodiment of the saddle illustrated in FIG. 6A. The saddle 40 and pivot arm 42 may be as described with respect to FIG. 6A. The pivot arm 42 may be strengthened and stabilized through a cantilever brace assembly 212. The brace assembly 212 may comprise a compression member 214 rigidly coupled at one end to the pivot arm 42, and pivotally coupled with a pivot connection 216 essentially identical to the pivot arm connection 46. The pivot connection 216 may be coupled with the hanger plate 48. It will be apparent to a person of ordinary skill in the relevant art that the pivot axes (not shown) of the pivot arm connection 46 and the pivot connection 216 must be coextensive.

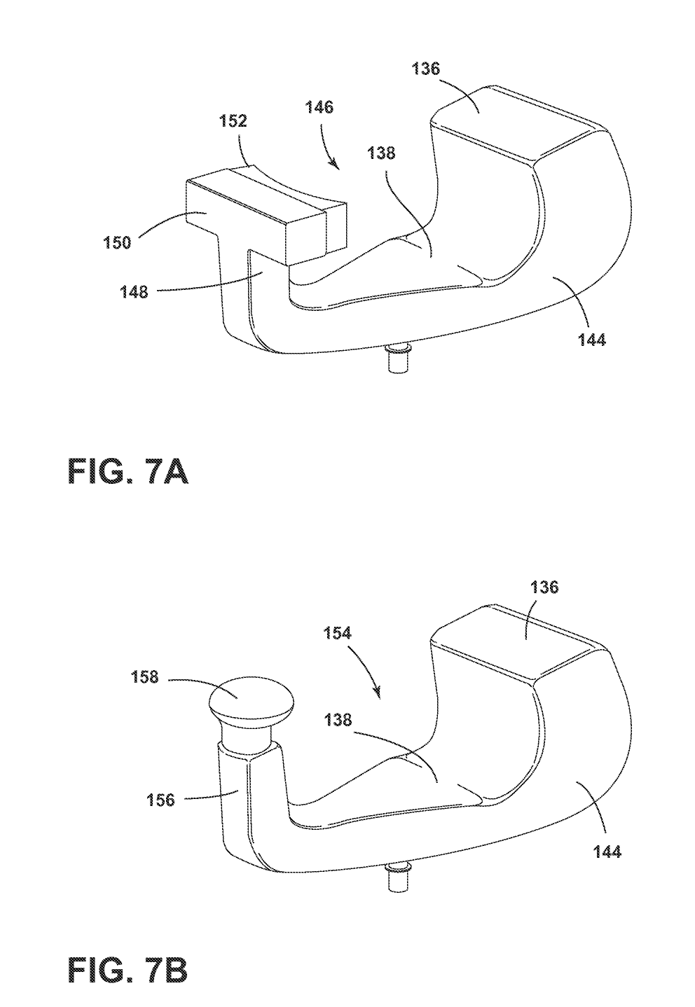

FIG. 7A illustrates a second embodiment 146 of the saddle in which the pommel may comprise an upright portion 148 transitioning upwardly to a lateral portion 150. The lateral portion 150 may extend orthogonally outward from the upright portion 148 to provide a broad area of contact with a hunter, thereby enhancing a sense of stability and support. The lateral portion 150 may be provided with a cushion 152. Moreover, the lateral portion 150 may extend toward the saddle back 136 to enhance a hunter's comfort while contacting the lateral portion 150.

FIG. 7B illustrates a third embodiment 154 of the saddle having a pommel similar to the pommel 142, except that a lower portion 156 may terminate in a somewhat spherical pommel grip 158. All other elements of the saddle 154 may be the same as in the saddle 40.

Referring to FIG. 6C, a second embodiment of a hanger plate assembly may include a multipurpose hanger plate 160. The hanger plate 160 does not support a saddle. Instead, the hanger plate 160 may include one or more hooks 162, 164 for hanging various items of use to a hunter in the field, such as clothing, food items, and the like. The hooks 162, 164 may be configured to accommodate items of different weight, shape, and use. For example, two horizontally aligned hooks 162, 164 may be configured to support a rifle.

The multipurpose hanger plate may also include a hanger arm assembly 170 comprising a hanger arm 172 connected at one end to the hanger plate 160 through a pivot connection 174. The opposite end of the hanger arm 172 may terminate in a selected functionality, such as an adjustable clamping mechanism 178 having a first gripper 180 and a second gripper 182, which may be adapted for holding an implement, such as a hunting bow 184. The hunting bow 184 may be selectively moved away from a hunter and to a hunter by pivoting the hanger arm 172. Alternatively, the hanger arm 172 may be adapted to hold items such as a still or video camera, floodlights, and the like. As with the above-described pivot connections, low-friction bearings may be utilized in the pivot connection 174.

Referring to FIG. 6D, a third embodiment of a hanger plate assembly may include a hanger plate 48 rigidly coupled with a basket 190 having a front wall 192, a bottom wall 194, and a pair of parallel, spaced sidewalls 196. The basket 190 may hold items of use to a hunter, such as arrowheads, firearm cartridges, personal items, and the like.

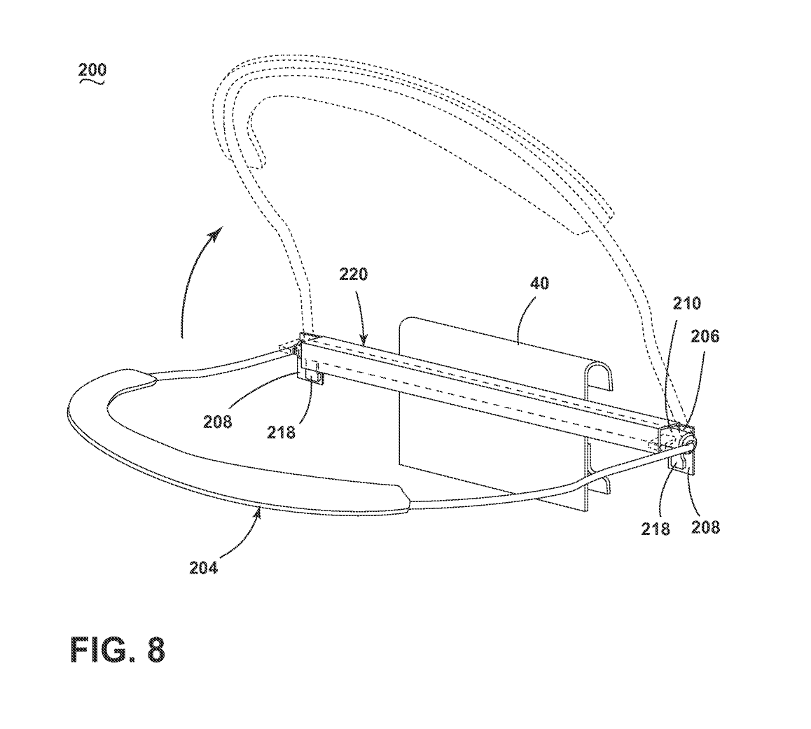

Referring now to FIG. 8, a gun rest assembly 200 may comprise a pivot beam 202 to which a gun rest 204 may be pivotally attached. The pivot beam 202 may be rigidly attached to a hanger plate 40 so that the gun rest assembly 200 may be generally perpendicular to the support frame 12 when the gun rest assembly 200 may be hung on a rung 20.

The pivot beam 202 may be a hollow elongate member adapted for receipt of a pivot pin 210 integrated with a pivot block 206. The gun rest 204 may be a somewhat arcuate member having a shape complementary to the arcuate configuration of the platform 80. The gun rest 204 may be rotated to an upward position when not utilized by a hunter, and downward to a horizontal position, when a hunter is utilizing it. As with other pivot connections described herein, the pivot pin 210 may rotate within the pivot beam 202, thereby enabling rotation of the gun rest 204.

To facilitate maintaining the gun rest 204 in a selected horizontal position, the pivot block 206 may include a stop arm 218 rigidly attached thereto and extending generally laterally away from the pivot block 206. A stop flange 208 may be rigidly attached to the pivot beam 202 to extend into the circular path of the rotating stop arm 218. When the gun rest 204 may rotate from a horizontal to a vertical position, the stop arm 218 may rotate away from the stop flange 208. When the gun rest 204 may rotate downwardly to a horizontal position, the stop arm 218 may rotate into contact with the stop flange 208, thereby maintaining the gun rest 204 in a horizontal, ready position.

The tree-mountable hunting stand with modular functionality described and illustrated herein provides several advantages to a hunter. First, a ladder-like support frame may be the base module through which all other modular elements may be utilized. The support frame may be fixed to a tree, or other pole-like structure, from the bottom, through the use of known, readily-available climbing steps, and at the top through the use of a ligature tightened around a tree to draw the support frame against a tree, and through pointed frame anchors extending from the support frame that may be embedded in a tree as the ligature is tightened. The use of multiple support points, serving as a “third hand,” may facilitate attachment of the support frame to a tree. In particular, the use of climbing steps provides a fixed resting stop while additional support frame attachment activities may continue.

Secondly, modularity may be achieved through the concept of a movable hanger plate adapted to support a variety of functionalities, which may be hung from one or more rungs of the support frame. For example, the hanger plate may be adapted with alternate functionalities, such as a double pivoting seat assembly, hangers, hanger arms, baskets, a pivoting gun rest, and the like. One hanger plate may provide one functionality.

The hanger plate may be vertically adjusted by simply lifting the hanger plate away from the rungs until the assembly may be moved away from the support frame. A different hanger plate with a different functionality may be coupled with the support frame by positioning the hanger plate so that downward movement may engage the suspension hooks with the rungs. In use, an outward force may act on the top suspension hook, which may be resisted by a connected rung, and an inward force acting on a lower portion of the hanger plate may be resisted by a rung in contact with the lower portion. The ability to pivot the gun rest away from a horizontal ready position to a vertical position, or to readily remove the gun rest and hanger plate from the support frame, may enable a hunter to tailor his or her hunting stand to the hunter's personal preferences.

Thirdly, a double pivoting seat assembly and curved platform may enable a hunter to rotate about a fixed point, i.e. saddle rotation, and move in a curve about the platform, thus providing a hunter with an increased field of view without compromising safety. The seat assembly may be coupled with the hanger plate to provide vertical adjustability. If the seat is not to be used, it may be readily removed from the support frame. Moreover, the incorporation of a pommel at the front of the saddle may provide a hunter with enhanced stability, balance, positioning, and comfort. The pommel may serve as an indicator of changes in positioning of a hunter, thereby enhancing safety.

Finally, pivoting of the platform about a horizontal axis enables the hunting stand to be readily disassembled and transported in a compact configuration. Various modular hanger plate assemblies may be completely removed from the support frame to be transported separately, while the support frame and platform may be compacted for storage in a relatively small area.

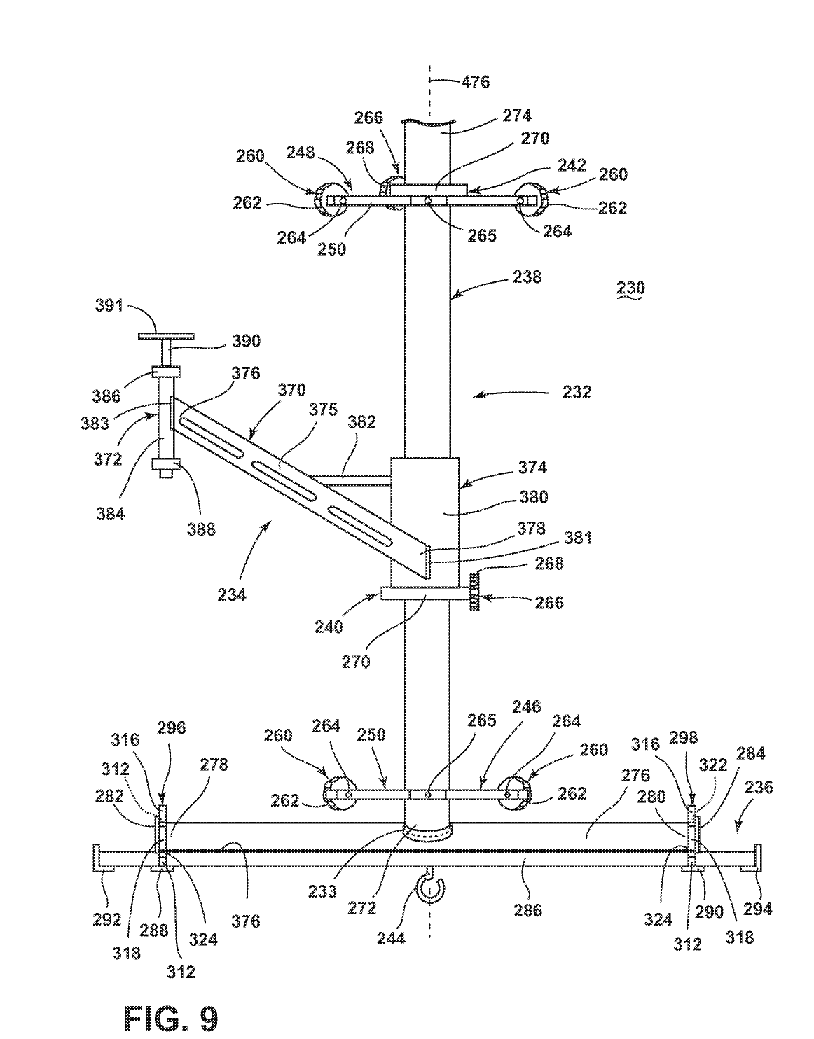

FIGS. 9-21 illustrate a modular tree-mountable hunting stand 230 according to an exemplary alternative embodiment of the invention. The modular hunting stand 230 shares structural elements and functionalities with the modular hunting stand 10. For example, both hunting stands 10, 230 comprise 3 principal modules, i.e. a support frame assembly module, a platform assembly module, and a saddle assembly module. Both support frame assembly modules comprise a frame rail, and may be securely attached to a tree by an anchoring assembly comprising embedment projections that may be driven into a tree, and a tightenable ligature assembly for urging the anchoring assembly against a tree. Both platform assembly modules comprise a platform for supporting a hunter that may be selectively rotated between a first orientation (typically vertical) and an orthogonally-disposed second orientation (typically horizontal). Both saddle assembly modules have a cantilevered beam with a first end pivotable about a first axis, and a second end supporting a saddle that is pivotable about a second axis parallel to the first axis. The first end of each cantilevered beam is supported by a plate assembly that may be selectively moved along the support frame assembly module to a selected distance above the platform assembly module. Each saddle assembly module comprises a saddle with an extending pivot shaft removably seated in a bearing, concentric with the second axis.

The modularity of the tree-mountable hunting stand 230 may be plainly evident from the description and drawings; thus the absence of the term “module” or “modular” in describing a structural element or assembly is not to be construed as a limitation on the modularity of the structural element or assembly, unless expressly stated otherwise. Reference may be made in describing the invention to an exemplary “person,” “user,” or “hunter.” These terms are equivalent, and are not to be construed as limiting the invention, unless expressly stated otherwise.

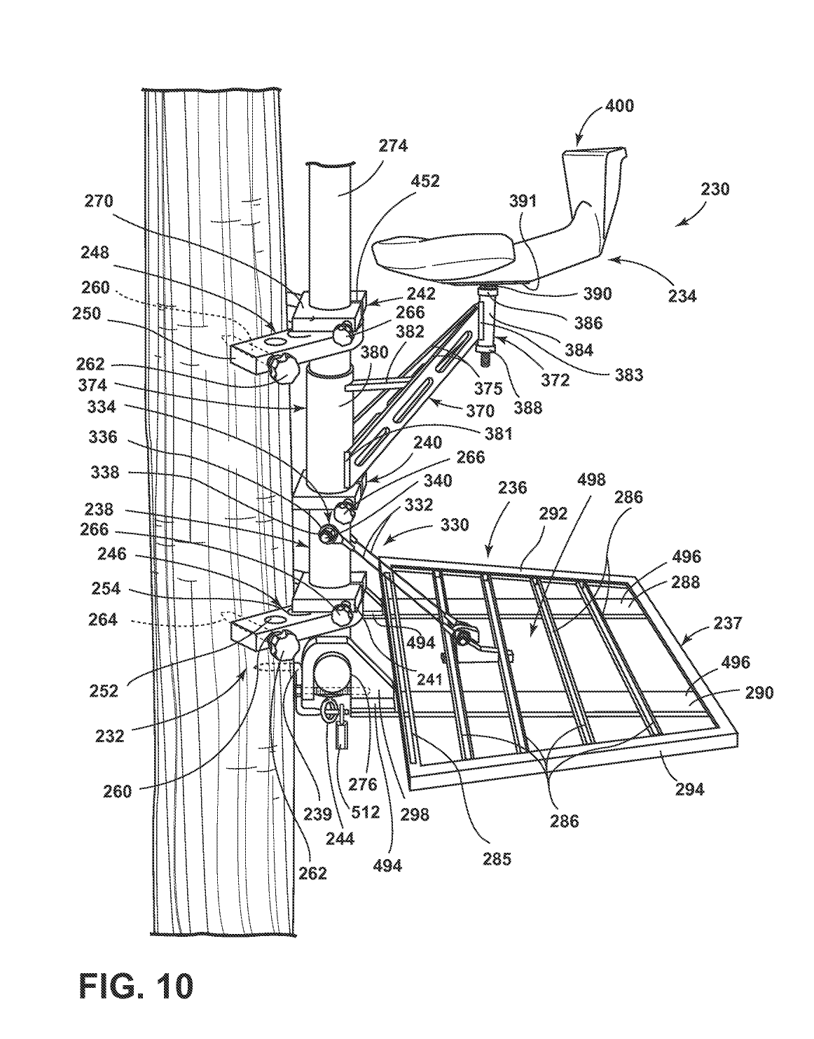

As illustrated in FIGS. 9 and 10, the hunting stand 230 may comprise an exemplary support frame assembly 232, an exemplary second embodiment saddle assembly 234, and an exemplary platform assembly 236, all of which may be coupled together into a somewhat open-frame configuration. The hunting stand 230 may comprise an assembly of suitably-dimensioned tubes, channel members, angle members, flat plates, and pieces having specialized configurations, all suitable for the purposes intended.

The hunting stand components may be fabricated of materials having properties, such as strength, weight, flexibility, durability, and the like, suitable for the purposes intended. Examples of such materials may include aluminum and steel in selected grades, high-strength plastics, or combinations thereof. The materials may also be selected based upon corrosion resistance, UV-based deterioration, resistance to air pollutants, and the like, particularly if the hunting stand may be subject to such conditions for extended periods of time. The hunting stand components may be selectively coated or surface treated for protection, aesthetics, or concealment of the hunting stand 230, and may be fitted with low-friction inserts, surfaces, bearings, and the like, to minimize or eliminate sound generated as a result of components moving in contact with one another or with external bodies.

The support frame assembly 232 may comprise a support frame rail 238 rigidly coupled with a pivot beam 276. The support frame rail 238 may comprise an elongate, smooth-walled, constant-diameter tube characterized by a support frame rail central longitudinal axis 476, and by a first support frame rail end 272 and a second opposed support frame rail end 274. The first support frame rail end 272 may be orthogonally coupled in rigid disposition with a midpoint of the elongate tubular, smooth-walled, constant-diameter pivot beam 276 to form an inverse T-shaped construction.

Alternatively, the support frame rail 238 may comprise a non-circular cross section, e.g. a square, an octagon, a rectangle, an oval, if rotation of the saddle assembly 234 about the support frame assembly 232 may be omitted.

The support frame rail 238 and pivot beam 276 may be rigidly coupled together in a suitable manner, such as by a weld 233 along a perimetric curve defined by the juncture of the support frame rail 238 with the pivot beam 276. Other coupling means may be utilized, such as threaded fasteners, compression fasteners, and the like, or threads on the first support frame rail end 272 to enable threading of the support frame rail 238 into a threaded receptacle associated with the pivot beam 276.

The support frame rail 238 may comprise a single selected length of rigid tubing. Alternatively, the support frame rail 238 may comprise different lengths of rigid tubing (not shown) having diameters equal to the diameter of the support frame rail 238, and coaxially coupleable into a modular support frame rail of a preselected length. It may be recognized that coupleable members may enable the assembly of a support frame rail 238 of virtually any length. Each tubing member may comprise a fastener assembly characterized, for example, by a length of threaded rod rigidly coupled with and extending coaxially from a first end of the tubing member, and a threaded receptacle rigidly coupled with and depending coaxially into an opposed second end of the tubing member. A first length of tubing may be coupled with a second length of tubing by threading a threaded rod of the first length of tubing into a threaded receptacle of the second length of tubing, and continuing this process until a support frame rail 238 of a selected overall length is constructed. The resulting support frame rail 238 may be characterized by a continuous smooth exterior surface.

Other coupling devices and/or methods may be utilized, with the understanding that the selected coupling device and/or method should provide a support frame rail 238 characterized by a continuous smooth exterior surface.

The pivot beam 276 may be characterized by a first end 278 and an opposed second end 280. The first end 278 may terminate in a solid circular first stop flange 282 concentric with the pivot beam 276 and having a diameter somewhat greater than the diameter of the pivot beam 276. Similarly, the second end 280 may terminate in a solid circular second stop flange 284 concentric with the pivot beam 276 and having a diameter equal to the diameter of the first stop flange 282. The solid circular stop flanges 282, 284 may be coupled with the pivot beam ends 278, 280 in a manner providing suitable strength and durability for the purposes described herein. An example of a suitable coupling may be a weld, a threaded connection, a friction or interference connection, and the like. A support ring 244, such as an eye bolt, a screw eye, and the like, may be rigidly coupled with the pivot beam 276, aligned with the centroid of the pivot beam 276, diametrically opposite the support frame rail 238, for purposes described hereinafter.

The modular support frame assembly 232 may comprise one or more frame anchor assemblies 246, 248, and one or more fixably adjustable hanger plate assemblies 240, 241, 242. Each frame anchor assembly 246, 248 may comprise a support frame plate 250, a pair of embedment projections 260, and a fixably adjustable hanger plate assembly 240, 241, 242. Each fixably adjustable hanger plate assembly 240, 241, 242 may comprise a hanger plate 270, and a threaded hanger plate tightener 266. The fixably adjustable hanger plate assemblies 240, 241, 242 may control the disposition e.g. positioning, height, etc., of the frame anchor assemblies 246, 248, saddle assembly 234, or any other apparatus with an operational height that may be selectively varied. This height variation may be accomplished by sliding a hanger plate 270 along the support frame rail 238 to a selected height, and fixing the hanger plate 270 in place, as hereinafter described.

In FIG. 9, the support frame assembly 232 is illustrated as comprising a first frame anchor assembly 246 without a fixably adjustable hanger plate assembly, and a second frame anchor assembly 248 with a second fixably adjustable hanger plate assembly 242, illustrated as an example of the variation in structure and application of the fixably adjustable hanger plate assemblies. As illustrated in FIG. 10, the first frame anchor assembly 246 may optionally be coupled with the support frame rail 238 through a third fixably adjustable hanger plate assembly 241 (or through alternative means). Both FIGS. 9 and 10 illustrate the saddle assembly 234 and the two frame anchor assemblies 246, 248, each assembly comprising a fixably adjustable hanger plate assembly 240, 241, 242.

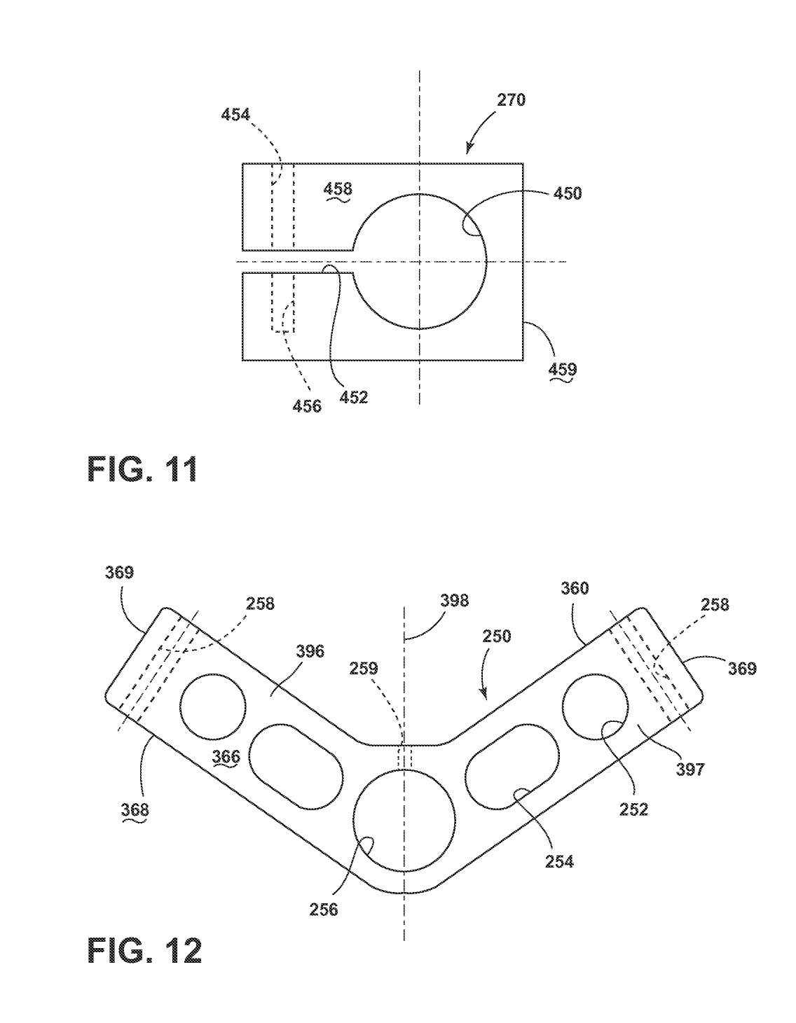

Referring also to FIG. 11, the hanger plate assemblies 240, 241, 242 may each comprise a flat rectangular hanger plate 270 characterized by parallel opposed planar surfaces 458, 459. The hanger plate 270 may comprise a circular support frame rail opening 450 extending therethrough from the first planar surface 458 to the second planar surface 459, to enable the hanger plate 270 to slidably move along the support frame rail 238 from a first disposition to a second disposition. Because a support frame rail may be characterized by a cross-section that is non-circular, e.g. square, rectangular, octagonal, and the like, the support frame rail opening may be characterized by a perimeter complementary to the non-circular cross-section of the support frame rail. The hanger plate assemblies 240, 241, 242 may be identical, or may be proportionate, or may be characterized by differing configurations selected, for example, by consideration of the particular use to which a hanger plate assembly may be put.

The circular opening 450 may be characterized by a diameter somewhat greater than the outside diameter of the support frame rail 238 for slidable translation of the fixably adjustable hanger plate assembly 240, 241, 242 relative to the support frame rail 238. The circular opening 450 may transition to a radially-disposed compression gap 452 that may cut through the hanger plate 270 to orthogonally intersect an end wall.

A circular tightener bore 454 may extend from a sidewall of the hanger plate 270 perpendicular to the compression gap 452. The tightener bore 454 may be smooth-walled, or threaded, and may continue across the compression gap 452 to a threaded tightener seat 456. The threaded tightener seat 456 may accommodate a threaded hanger plate tightener 266 with an integral knurled tightener handle 268, or a cap screw, an Allen screw, a flange bolt, a wing screw, and the like. The hanger plate assembly 240, 241, 242 may be slidably joined with the support frame rail 238, and, utilizing the threaded hanger plate tightener 266, the compression gap 452 may be narrowed so that the circular opening 450 may be tightened around the support frame rail 238 at a selected location.

The circular opening 450 and compression gap 452 may be characterized as a “keyhole,” by which reference may be made hereinafter to the combined opening 450 and gap 452. The keyhole 450/452 may have alternative configurations, e.g. the compression gap 452 may extend from the circular opening 450 to intercept a corner of the hanger plate 270. The keyhole 450/452 may define a pair of opposed mirror-image flexible extensions, or “wings,” joined along an imaginary planar surface oriented orthogonally to the first and second planar surfaces 458, 459, and diametrically opposite the compression gap 452. The compression gap 452 may be selectively narrowed by moving the flexible wings bordering the compression gap 452 toward one another. Narrowing the compression gap 452 may reduce the dimensions of the keyhole 450/452, thereby enabling the assembly 240, 241, 242 to be fixedly coupled with the support frame rail 238 at a selected location. Other means of narrowing the compression gap 452 may be employed, e.g. an over-center latch mechanism having sufficient strength and durability for the purposes intended.

The hanger plate 270 may alternatively have a curved configuration in plan, e.g. circular or oval, while utilizing the tightener bore 454 and threaded hanger plate tightener 266. The compression gap 452 may be omitted, and a threaded bore (not shown) may extend from the perimeter of the hanger plate 270 radially into the circular opening 450. A matching threaded tightener may be turned into the threaded bore and against the support frame rail 238 to enable a fixably adjustable hanger plate assembly 240, 241, 242 to be fixedly coupled with the support frame rail 238 at a selected location.

Under suitable circumstances, such as increasing the load capacity of the hunting stand 230, a plurality of fixably adjustable hanger plate assemblies may be stacked and tightened in place along the support frame rail 238, thereby multiplying the load capacity of a single fixably adjustable hanger plate assembly 240, 241, 242. It may be recognized that, in any case, a fixably adjustable hanger plate assembly 240, 241, 242 may be precisely positioned at a selected one of an unlimited number of locations along the support frame rail 238 by tightening the fixably adjustable hanger plate assembly 240, 241, 242 at the selected location, thereby optimizing the performance and safety of the tree-mountable hunting stand 230 for any hunter.

Referring also to FIG. 12, the first frame anchor assembly 246 may comprise a bilaterally-symmetrical somewhat V-shaped support frame plate 250 adapted for receipt of a pair of threaded embedment projections 260. The second frame anchor assembly 248 may comprise an identical bilaterally-symmetrical somewhat V-shaped support frame plate 250 adapted for receipt of a pair of threaded embedment projections 260. Each support frame plate 250 may be characterized by first and second support frame plate arms 396, 397, respectively, together defining an obtuse angle. A first fixably adjustable hanger plate assembly 240 and a second fixably adjustable hanger plate assembly 242 may be selectively fixedly coupled with the support frame rail 238 to maintain the support frame rail 238 at a selected location relative to the hanger plate assemblies 240, 242, and a tree. As may be recognized in FIG. 10, the hanger plate assemblies 240, 242 may be tightened along the support frame rail 238 above the frame anchor assemblies 246, 248 in order to rest upon a planar surface 366, 368 of the frame anchor assemblies 246, 248, which are immovably attached to a tree, thereby suspending the support frame rail 238, and everything coupled with it, at the selected location.

Each support frame plate 250 may comprise a pair of parallel opposed planar surfaces 366, 368. Each support frame plate arm 396, 397 may terminate in a planar end wall 369 orthogonally disposed to join the planar surfaces 366, 368. Each support frame plate 250 may be characterized by an axis of symmetry 398 intersecting the vertex of the support frame plate 250, and extending diametrically through a circular support frame rail opening 256.

The circular support frame rail opening 256 may extend through each support frame plate 250 from the first planar surface 366 to the second planar surface 368 so that a diameter of the circular opening 256 may be collinear with the axis of symmetry 398. The circular opening 256 may be characterized by a diameter somewhat greater than the outside diameter of the support frame rail 238. The support frame rail 238 may be inserted through the circular opening 256 for slidable translation of the support frame plate 250 along the support frame rail 238. It may be appreciated that the circular opening 256 may be lined with a low friction material, such as polytetrafluoroethylene, nylon, and the like, or mechanical devices, such as ball bearings or sealed bearings, to minimize sound that may be produced when translating the support frame plate 250 along the support frame rail 238.

Each support frame plate 250 may comprise a threaded support frame rail bore 259 extending into the support frame plate vertex, coaxially with the axis of symmetry 398, to intersect the circular opening 256, for receipt of a threaded tightener, as hereinafter described.

A threaded cylindrical embedment projection bore 258 characterized by an embedment projection bore central longitudinal axis may extend through each support frame plate arm 396, 397, adjacent and parallel to the end wall 369, and parallel to the planar surfaces 366, 368. The threaded embedment projection 260 may be a steel rod-like member having a knurled handle 262 at a first end, an embedment point 264 at a second end, and a threaded shaft extending therebetween for operative registry with the threaded embedment projection bore 258. The embedment projection 260 may be turned in the embedment projection bore 258 to controllably drive the embedment projection 260 through the embedment projection bore 258 so that the embedment point 264 may penetrate a tree.

A plurality of through openings 252, 254 may extend through each support frame plate arm 396, 397 from the first planar surface 366 to the second planar surface 368, and between the circular opening 256 and the threaded embedment projection bore 258. An elongate ligature through opening 254, having a discorectangular or stadium shape, may be symmetrically disposed along each support frame plate arm 396, 397 beginning adjacent the circular opening 256. A circular ligature through opening 252 may be similarly disposed along each support frame plate arm 396, 397 between the elongate ligature through opening 254 and the threaded embedment projection bore 258. The through openings 252, 254 may contribute to a reduction in the weight of the support frame plate 250, compared to a solid support frame plate.

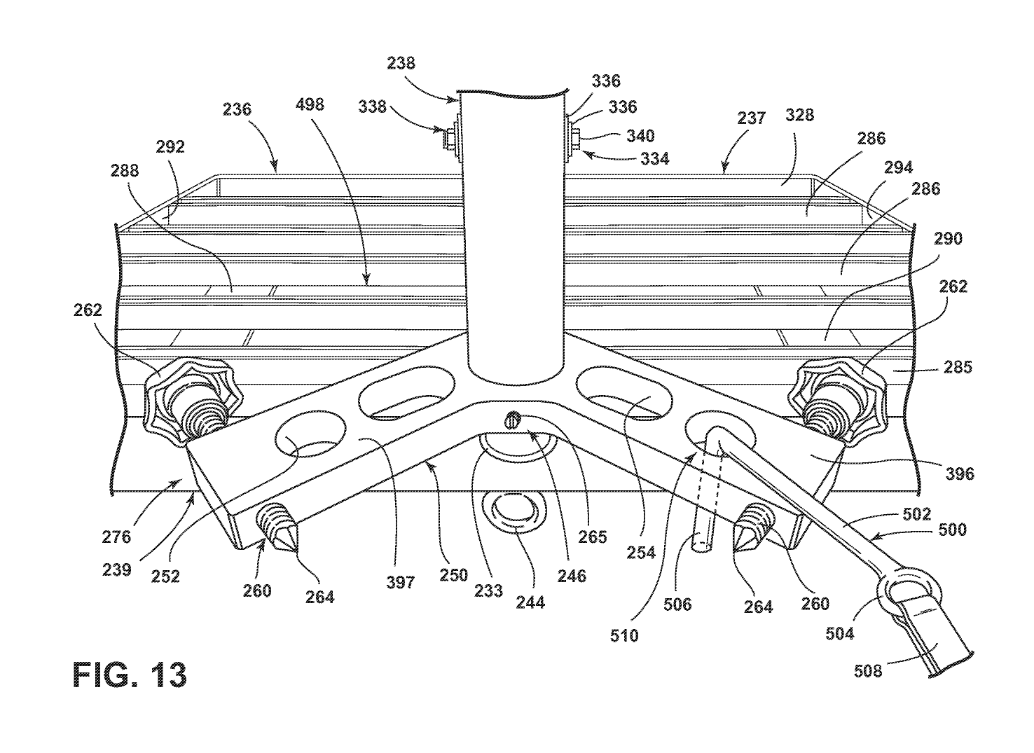

Referring to FIG. 13, a ligature assembly 500 may comprise a ligature 508, such as an inelastic strap, coupled with a metal connector, e.g. a steel hook 510. As an alternative to the inelastic strap 508, a cable, a wire rope, and the like, may be utilized, characterized by properties, such as strength, flexibility, elasticity, and the like, suitable for the purposes described herein. The hook 510 may comprise an elongate member characterized by a shank 502 transitioning at a first end to an annular eye 504 and at a second opposed end to a hook finger 506 extending generally orthogonal to the shank 502. Each end of the ligature 508 may be coupled with the eye 504 through a means providing sufficient strength and durability for the purposes intended. Alternative hook finger configurations, such as curved, 2-pronged, lockable, and the like, may provide enhanced resistance to separation of a hook finger from a through opening 252, 254.

The ligature assembly 500 may movably couple a support frame plate 250 to a tree. For example, a first hook 510 coupled with an end of the ligature 508 may be coupled with the first support frame plate arm 396 by inserting the hook finger 506 through the first opening 252. A free end of the ligature 508 coupled with a second hook 510 may be passed around a tree and coupled with the second support frame plate arm 397 so that the support frame plate 250 may be held against a tree. The ligature 508 may then be tightened to urge the support frame plate 250 against a tree by utilizing, for example, a strap tensioner, turnbuckle, winch, ratchet, and the like (not shown). Tightening the ligature 508 around a tree may drive exposed embedment points 264 into a tree, which may enhance the strength of the frame plate-to-tree connection.

The elongate ligature through openings 254 may be used for the same purpose, for example, on a tree characterized by a smaller diameter, which may increase the area of contact of the ligature with a tree, or for enabling the use of an additional ligature assembly, which may increase the strength, and factor of safety, of the frame plate-to-tree connection.

The first frame anchor assembly 246 and the second frame anchor assembly 248 may be spaced along the support frame rail 238 to provide solid anchoring of the hunting stand 230 to a tree. The first frame anchor assembly 246 may be positioned along the first support frame rail end 272, near the pivot beam 276. The second frame anchor assembly 248 may be positioned along the second support frame rail end 274. It may be recognized that the frame anchor assemblies 246, 248 may be located elsewhere along the support frame rail 238, for example, to avoid obstacles, such as branches or curved sections, or other irregularities. If a frame anchor assembly may be integrated with an accessory, such as those described with respect to the first embodiment hunting stand 10, the frame anchor assembly may be positioned along the support frame rail 238 to locate the accessory where its accessibility and/or its use may be optimized.

Though not illustrated, additional frame anchor assemblies may be coupled with the support frame rail 238 at selected locations to provide additional anchor points along a tree. This may be advantageous, for example, to increase the load-carrying capacity of the hunting stand 230, or to accommodate irregularities in a tree that may complicate attachment of the hunting stand 230, e.g. tree bark surface interruptions, limb size and/or spacing, and the like.

The support frame plate 250 may be rigidly attached to the support frame rail 238, for example, through a suitable threaded fastener, such as a set screw 265, turned in the threaded support frame rail bore 259 (FIG. 13). This may enable the set screw 265 to engage the support frame rail 238 at the circular opening 256. Alternative fasteners may include an Allen screw, an embedment projection 260, a hex-head bolt, and the like.

An opening (not shown) may extend through the annular wall of the support frame rail 238 so that a threaded fastener may be installed through the support frame rail bore 259 and the wall of the support frame rail 238. The opening in the support frame rail 238 may be threaded or unthreaded. This may be advantageous if the location of a support frame plate 250 along the support frame rail 238 may be unchanged over an extended period of time, such as for the duration of an extended hunting season. Alternatively, an opening may extend diametrically through the support frame rail 238 and the support frame plate 250 (e.g. a continuation of the threaded support frame rail bore 259 along the axis of symmetry 398) so that a threaded fastener may be inserted through the support frame plate 250 and support frame rail 238, and fixed in place by a nut. Alternatively, a removable pin (not shown) may be used in generally the same manner as the threaded fastener and nut. A dimple (not shown) may be formed in the wall of the support frame rail 238 for receipt of a tapered or conical tip of a threaded fastener whereby the fastener tip may be tightly turned into the dimple so that the support frame plate 250 may resist movement along the support frame rail 238.

A plurality of support frame plates 250 may be removably fixed along the support frame rail 238 through the use of a plurality of fixably adjustable hanger plate assemblies 240, 241, 242. A fixably adjustable hanger plate assembly 240, 241, 242 may be selectively clamped to the support frame rail 238, as described hereinbefore, above a support frame plate 250. In this configuration, with the support frame plate 250 attached to a tree, the support frame rail 238 may be slidably movable through the circular opening 256 until the fixably adjustable hanger plate assembly 240, 241, 242 contacts the top of the support frame plate 250. The support frame rail 238 may then be suspended from the support frame plate 250 by the fixably adjustable hanger plate assembly 240, 241, 242 resting upon the support frame plate 250.

It may also be appreciated that fixably adjustable hanger plate assemblies may be utilized to couple accessories, such as those described with respect to the first embodiment hunting stand 10, with the support frame rail 238. For such uses, additional fixably adjustable hanger plate assemblies may be attached to the support frame rail 238 at virtually any location, independently of the hanger plate assemblies 240, 241, 242 associated with frame anchor assemblies 246, 248 and the primary saddle assembly bearing 380. It may also be appreciated that fixably adjustable hanger plate assemblies associated with accessories may be the same as the hanger plate assemblies 240, 241, 242, and may be utilized to support an accessory coupled with a sleeve, such as the bearing 380. Alternatively, an accessory, such as a firearm holder, may incorporate a fixably adjustable hanger plate assembly into a single integrated device. In any case, frame anchor assemblies may be precisely positioned at a selected one of an unlimited number of locations along the support frame rail 238, thereby optimizing the performance and factor of safety of the tree-mountable hunting stand 230 for any hunter.

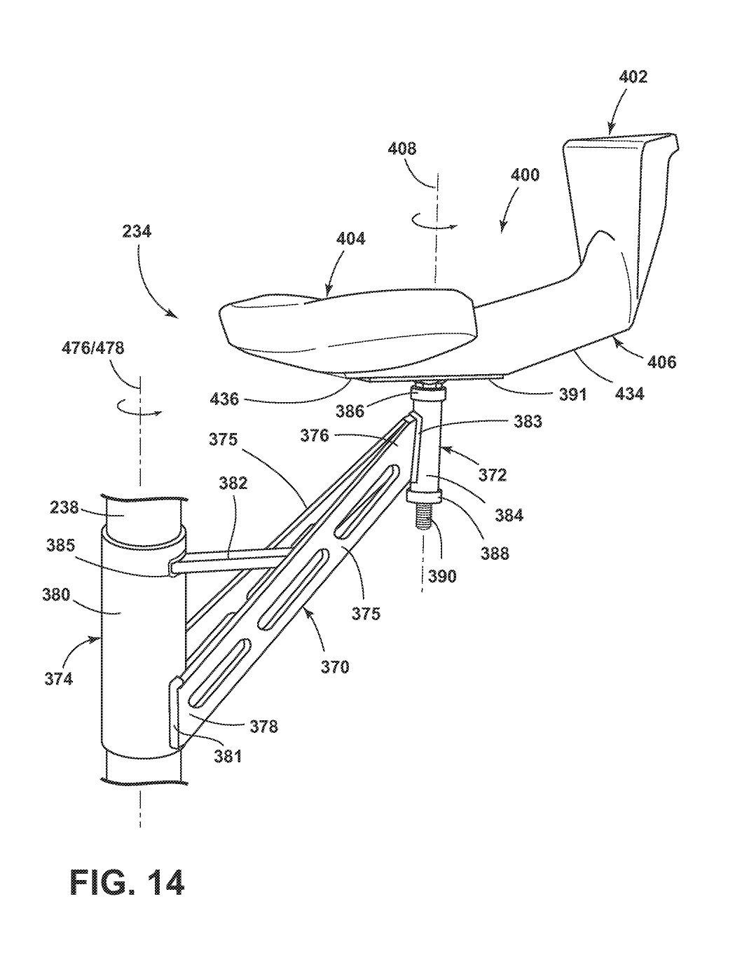

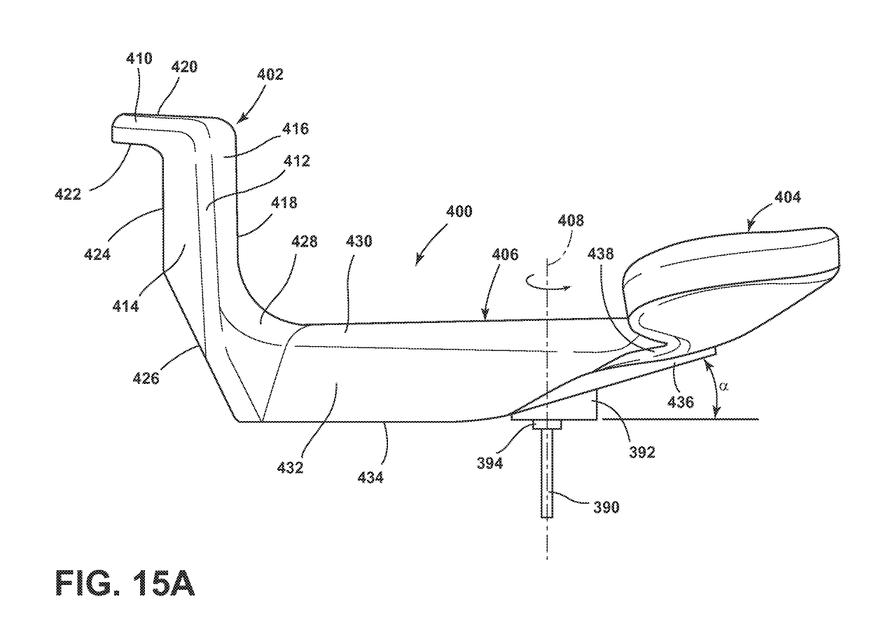

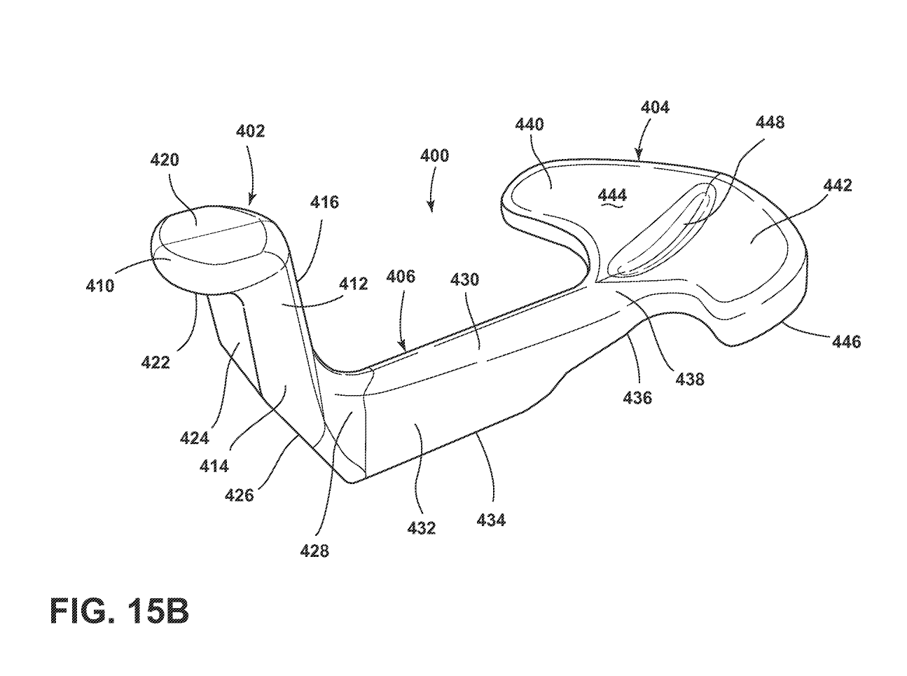

Referring to FIGS. 14, 15A, and 15B, the second embodiment saddle assembly 234 may comprise a pivot arm assembly 370, a saddle bearing assembly 372, a support frame bearing assembly 374, and a fourth embodiment saddle 400. The pivot arm assembly 370 may comprise an exemplary pair of elongate primary support members 375 collectively characterized by a distal end 376 and a proximal end 378. A secondary support member 382 may be coupled with the primary support members 375 into a rigid subframe.

The saddle bearing assembly 372 may comprise an exemplary annular bearing housing 384 coaxially terminating at a first end in a first end bearing 386 and at a second end in a second end bearing 388. The support frame bearing assembly 374 may comprise a primary saddle assembly bearing 380, supported upon a fixably adjustable hanger plate assembly 240, 241, 242, as described in detail hereinbefore. The saddle 400 may comprise a pommel portion 402 and a saddle support portion 404 coupled together through a straddle portion 406, and rotatable about a saddle rotational axis 408 coaxial with a pivot shaft 390.

The primary support members 375 may be configured with the distal ends 376 in contact, and the proximal ends 378 in spaced disposition. The proximal ends 378 of the primary support members 375 are illustrated in FIG. 9 as obliquely coupled with the primary saddle assembly bearing 380 by welds 381. A weld 383 may rigidly couple the distal ends 376 with the bearing housing 384, described hereinafter.

The secondary support member 382 is illustrated as a tension member, which may extend in a radially perpendicular orientation from the bearing 380 to the primary support members 375. The secondary support member 382 may be rigidly coupled at a first end with the bearing 380 through a weld 385, and at an opposed second end (not shown) with the primary support members 375, also through a weld. The welded configuration may provide a rigid framework for strength, and to eliminate uncontrolled flexural movement of the pivot arm assembly 370. Welds may be fillet welds, or other weld configurations having suitable properties. Alternatively, saddle assembly elements may be connected using fasteners, mechanical joints, combinations of joining methods, and the like.

It may be appreciated that the pivot arm assembly may comprise a single primary support member extending obliquely from the primary saddle assembly bearing 380 to the bearing housing 384. A single secondary support member may also extend from the primary saddle assembly bearing 380 to the single primary support member. Coupling of the bearings and members may be accomplished through welding or other methods.

The saddle bearing assembly 372 may comprise the bearing housing 384 coaxially terminating at a first end in a first end bearing 386 and at a second end in a second end bearing 388. The bearing housing 384 and end bearings 386, 388 may coaxially enclose the pivot shaft 390 extending from the saddle 400. The bearing housing 384 and/or end bearings 386, 388 may comprise low friction materials, such as polytetrafluoroethylene, nylon, and the like, or mechanical devices, such as ball bearings or sealed bearings. For example, the bearings 386, 388 may comprise ball bearing assemblies rigidly attached to the bearing housing 384. Alternatively, nylon rings may closely encircle the pivot shaft 390 to enable slidable rotation and translation. It may be recognized that the bearings and bearing materials may be selected, in part, based upon properties enabling the pivot shaft 390 to rotate and translate silently within the bearing housing 384 and bearings 386, 388.

The pivot shaft 390, the bearing housing 384, and the end bearings 386, 388 may be configured so that the pivot shaft 390 may be readily removable from the saddle bearing assembly 372, thereby enabling removal of the saddle 400 from the saddle bearing assembly 372.

The primary saddle assembly bearing 380 may be characterized as an annular member having an inner diameter enabling slidable circumscribing engagement of the primary saddle assembly bearing 380 with the support frame rail 238. Tolerances between the inside diameter of the bearing 380 and the outside diameter of the support frame rail 238 may be selected to minimize angular deviation of the bearing 380 from the central longitudinal axis 476 of the support frame rail 238, thereby minimizing sound generated by an eccentric rotation of the bearing 380 about the support frame rail 238, and optimizing stability of the saddle assembly 234. The interior annular surface of the primary saddle assembly bearing 380 may be lined with a low friction material, such as polytetrafluoroethylene, nylon, and the like, or may include one or more mechanical devices, such as ball bearings or sealed bearings, between the primary saddle assembly bearing 380 and the support frame rail 238.

The saddle bearing assembly 372 and the support frame bearing assembly 374 may be configured so that the saddle rotational axis 408 may be parallel with the support frame rail longitudinal axis 476 and the pivot arm rotational axis 478. A low friction material may be applied to surfaces of one of or both the primary saddle assembly bearing 380 and hanger plate 270 in contact with one another so that the generation of noise from rotation of the saddle assembly bearing 380 on the hanger plate 270 may be minimized.

As illustrated in FIG. 9, the support frame bearing assembly 374 may rest upon a fixably adjustable hanger plate assembly 240 that may be clamped as described hereinbefore to support the support frame bearing assembly 374 at a selected one of an unlimited number of locations along the support frame rail 238. Precise positioning of the saddle bearing assembly 372 and saddle 400 relative to the platform assembly 236 may accommodate the physical characteristics and capabilities, e.g. height, weight, strength, endurance, age, of a user of the tree-mountable hunting stand 230, thereby optimizing the performance and safety of the hunting stand 230 for any user. For example, the threaded hanger plate tightener 266 of the fixably adjustable hanger plate assembly 240 may be unscrewed sufficiently to open the compression gap 452 and release the hanger plate assembly 240 from its first disposition along the support frame rail 238. The support frame bearing assembly 374 and adjustable hanger plate assembly 240 may then be moved to a selected location along the support frame rail 238, and the threaded hanger plate tightener 266 may be retightened to clamp the hanger plate assembly 240 to the support frame rail 238 at a second disposition. The functionality of the hanger plate 270 and the threaded hanger plate tightener 266 may assist in optimizing the position of the saddle 400 by enabling tightening, moving, and retightening to be readily repeated without the need for tools and with relatively little effort.

Referring again to FIGS. 14, 15A and 15B, the pommel portion 402 may comprise a solid somewhat rounded flattened pommel grip 410 comprising a top wall 420 and an under wall 422. A solid elongate pommel 412 may extend generally orthogonally away from the straddle portion 406 to terminate in the pommel grip 410. The pommel 412 may be characterized by a convex in-facing wall 416 extending from the pommel grip 410 to the straddle portion 406 toward the saddle support portion 404. A pair of opposed planar sidewalls 414, 418 may transition from the inner wall 416 forward to define laterally oriented faces of the pommel 412. A planar forward-facing outer wall 424 may transition away from the under wall 422 to a planar inclined outer wall 426. The pommel 412 may be coupled with the straddle portion 406 through a smoothly curved first transition portion 428.

The straddle portion 406 may be a solid linear, i.e. narrow and elongated, member characterized by a convex top wall 430 transitioning smoothly to a pair of opposed divergent sidewalls 432. The sidewalls 432 may terminate in an orthogonally disposed planar bottom wall 434 extending between the sidewalls 432. In cross-section, the straddle portion 406 may be characterized as generally triangular. The width of the straddle portion 406 may be less than the width of both the pommel portion 402 and the saddle support portion 404. The width of the straddle portion 406, defined by the width of the planar bottom wall 434, may enable a user to adopt a somewhat relaxed standing posture, with the user's legs spaced naturally apart, while straddling the straddle portion 406. A user may transfer along the straddle portion 406 from the saddle support portion 404 to the pommel portion 402 while minimizing vertical movement. The straddle portion 406 may also enable a user in a straddling posture to control the rotation, and thus the position, of the saddle 400 with the user's legs, freeing the user's hands for other tasks.

The straddle portion 406 may be coupled with the saddle support portion 404 through a smoothly curved second transition portion 438 characterized by an inclined planar saddle wall 436 continuing from the planar bottom wall 434.

The saddle support portion 404 may be characterized by a somewhat bilaterally-symmetrical partially arcuate body comprising a first saddle wing 440 and an opposed second saddle wing 442 collectively defining a shallow concave support surface 444 transitioning smoothly from the second transition portion 438. The saddle support portion 404 may be characterized by a curved perimetric wall 446 defining an edge along the first and second saddle wings 440, 442. The support surface 444 may be bisected by an elongate coccygeal depression 448 extending somewhat below the support surface 444 between the first and second saddle wings 440, 442.

The saddle rotational axis 408 may extend through the straddle portion 406 at a point corresponding generally to a center of gravity of the saddle 400. It may be appreciated that the location of the center of gravity may vary as a consequence of variations in the forces applied to the saddle 400 by a person utilizing the saddle 400, e.g. the weight of a person supported by the saddle 400, the location relative to the saddle 400 of the forces associated with a person, and the like.

The saddle 400 may be characterized by alternative configurations differing from the configuration shown in FIGS. 14 and 15A-B, such as in wall geometries, surface transition lines, relative dimensions, and the like, and the saddle embodiments herein described and illustrated are merely examples. The saddle 400 may be fabricated of a high-strength polymer, fiberglass, aluminum, and the like, having strength, durability, and weight properties suitable for the purposes described herein.

FIG. 14 illustrates an embodiment of the saddle 400 comprising a saddle mounting plate 391 attached to the inclined saddle wall 436. FIG. 15A illustrates an alternative embodiment of the saddle 400 comprising a wedge-shaped saddle mounting block 392 having an angle of inclination α, also attached to the inclined saddle wall 436. In another embodiment (not shown), the mounting plate 391 may be attached to the bottom wall 434. Depending upon whether a mounting plate 391 or a mounting block 392 may be utilized, and to which surface the mounting plate 391 or mounting block 392 may be attached, the inclination of the saddle 400, particularly the straddle portion 406, may be generally horizontal or may be inclined so that the elevation of the pommel portion 402 may be higher than the saddle support portion 404.

The saddle mounting plate 391 and saddle mounting block 392 may be selectively attached to the inclined saddle wall 436 or bottom wall 434 with fasteners, such as threaded screws, adhesives, combinations of fastening methods, and the like. The saddle mounting plate 391 and saddle mounting block 392 may be coupled with the mounting block bearing 394 and the pivot shaft 390 by welding the components together. Alternatively, the mounting plate or mounting block, mounting block bearing 394, and pivot shaft 390 may be fabricated as a single piece.

The saddle 400 may be used in a manner other than supporting the substantially full weight of a seated hunter by the saddle support portion 404. For example, the saddle 400 may augment the balance of a hunter while in a primarily standing position. To alleviate fatigue associated with standing for an extended period of time, a hunter may stand astride the straddle portion 406 in sufficient contact with the saddle support portion 404 to transfer some of the hunter's weight to the saddle support portion 404. A fraction of the hunter's weight may comprise a limited downward vertical force to the saddle support portion 404, the remainder of the hunter's weight being carried by the hunter's legs.

Alternatively, a hunter's abdomen may engage the pommel portion 402. A hunter observing prey within a suitable range may move horizontally away from the saddle support portion 404 and into contact with the pommel portion 402 to prepare for a shot. If the straddle portion 406 is at an elevation just beneath the hunter's pelvis, this movement may be essentially horizontal. If a small portion of the hunter's weight may be supported by the saddle support portion 404, i.e. a hunter may be in a primarily standing position, this movement may be vertically abbreviated, reducing the likelihood that it will be noticed by the prey. Furthermore, the narrow width of the straddle portion 406 may facilitate the hunter's even, uninterrupted movement between the saddle support portion 404 and the pommel portion 402.

A hunter may stand astride the straddle portion 406 and lean into the pommel portion 402, applying an outward horizontal force to the pommel portion 402, and using the pommel grip 410 and the pommel 412 to maintain balance while motionless, moving, or shooting. A hunter may move in a circular path to adjust the hunter's line of sight while supported by the saddle support portion 404 or leaning into the pommel portion 402. This movement may comprise rotation about the saddle rotational axis 408, rotation about the pivot arm rotational axis 478, or a combination of both. Thus, a hunter may rotate 360° about the saddle rotational axis 408, and may enhance his or her concealment by facing a tree if the prey is on the opposite side of a tree from the hunting stand. Precise rotation may be readily carried out with little resistance as a result of the use of low-friction bearings. In any case, such movement may be essentially noiseless, and at the same time may position a hunter with a view optimizing the likelihood of capturing the prey.

If the saddle 400 may be utilized to support a different magnitude of a hunter's weight on the saddle support portion 404, the center of gravity defined by the hunter's weight and the saddle 400 may be relocated, thereby separating the center of gravity from the saddle rotational axis 408. Thus, there may be an advantage in minimizing weight borne by the saddle support portion 404 by maintaining close to a complete standing posture.

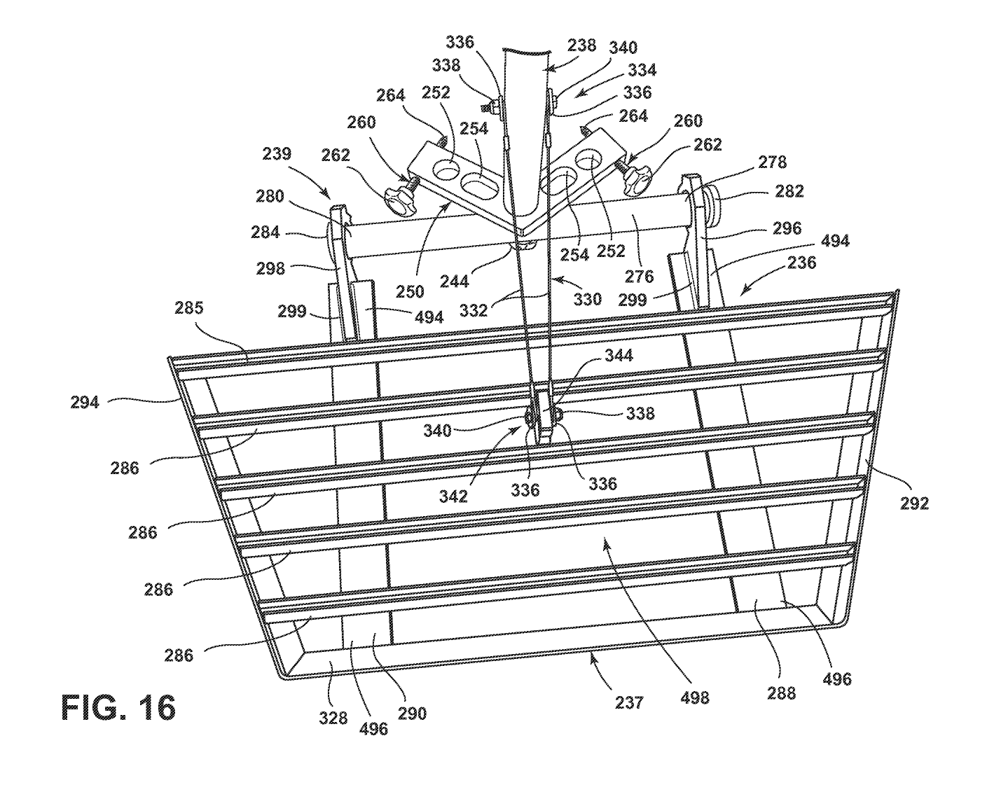

Referring again to FIGS. 9, 10, and 13, and to FIG. 16, the exemplary platform assembly 236 may comprise a planar support platform 498 characterized by a platform distal end 237 and a platform proximal end 239. A plurality of elongate platform members 286, and a proximal platform member 285, may comprise an open-frame platform surface upon which a person may stand and/or items may be supported. The platform members 285, 286 may be square tubular or channel pieces arranged in fixed parallel spaced disposition. First and second platform straps 288, 290 may comprise elongate flat narrow members, each characterized by a proximal platform strap end 494 and an opposed distal platform strap end 496. The platform straps 288, 290 may extend in spaced parallel disposition from the platform distal end 237 to the platform proximal end 239, and may be orthogonally disposed beneath the platform members 285, 286.

The planar support platform 498 may have a somewhat trapezoidal shape comprising 5 parallel spaced platform members 286, although the number of members may be other than the 5 illustrated. Alternatively, the planar support platform 498 may be in the shape of a circular sector or truncated circular sector, a parallelogram, a combination of shapes, and the like. A first platform edge member 292 and a second platform edge member 294 may extend along, and be coupled with, the ends of the platform members 286. The platform edge members 292, 294 may be disposed at an acute angle to the platform straps 288, 290, and to one another. The platform distal end 237 may comprise a third platform edge member 328, with which the distal platform strap ends 496 may be coupled, disposed orthogonally to the platform straps 288, 290. The third platform edge member 328 may be disposed parallel to the platform members 285, 286. The platform edge members 292, 294, 328 may comprise an angle, a channel, or other cross-section, suitable for the purposes described herein, including coupling with the platform members 285, 286 and platform straps 288, 290. The distal platform strap ends 496 may be rigidly coupled with the third platform edge member 328

The platform members 286, platform straps 288, 290, and platform edge members 292, 294, 328 may be rigidly intercoupled into an open-frame by a means of attachment having suitable strength, durability, and other relevant properties, for the purposes described herein, such as welding, threaded fasteners, riveting, and the like.

While the planar support platform 498 is illustrated as trapezoidal, the planar support platform 498 may have an alternative shape, such as a semicircle, rectangle, square, fan, major circular sector, and the like. Additionally, the planar support platform 498 may alternatively have a closed configuration rather than an open-frame configuration. In such a case, the platform members 286 may serve as supports over which a thin, sheet-like surface element may be installed.

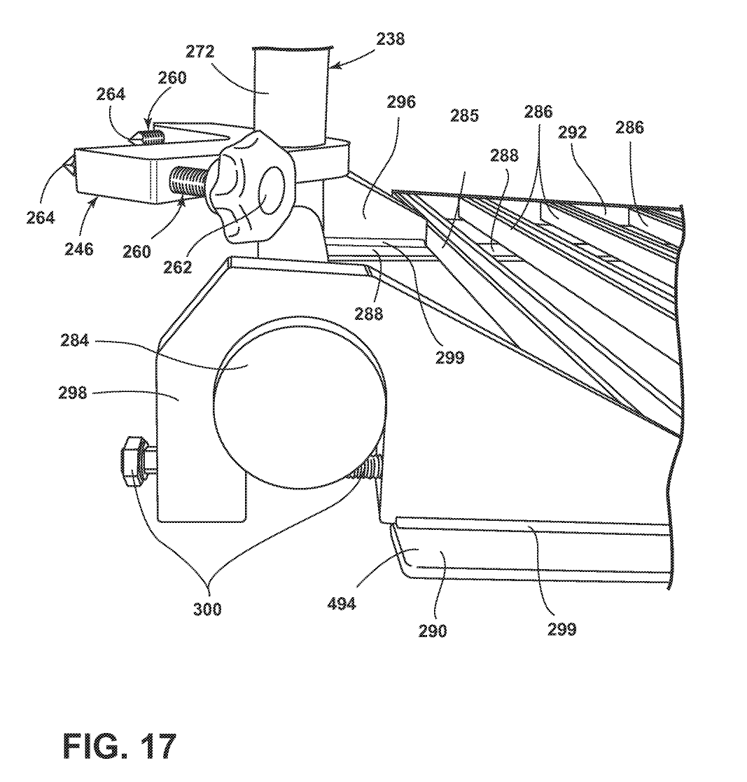

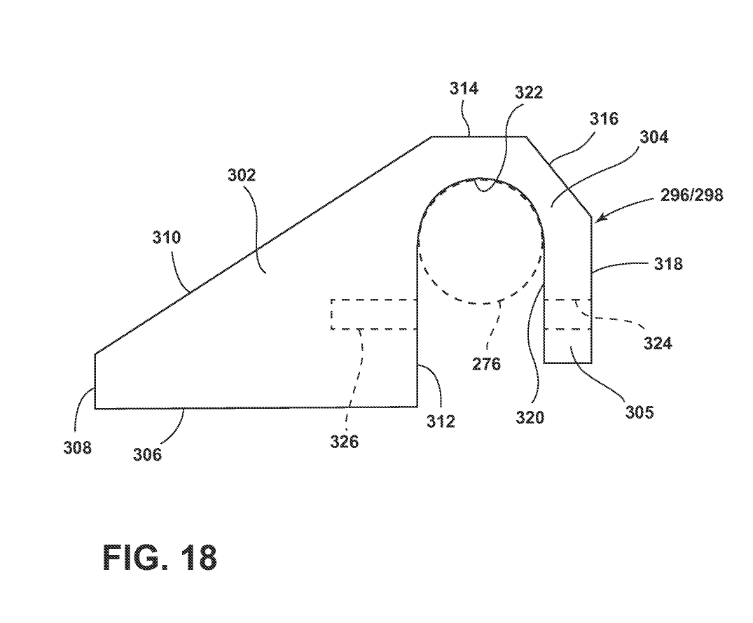

Referring now to FIGS. 17 and 18, the platform assembly 236 may comprise a first platform pivot bracket 296 and a second platform pivot bracket 298 coupleable with the support frame assembly 232 to enable the platform assembly 236 to be pivotably attached to the pivot beam 276. The platform pivot brackets 296, 298 may be identical, each comprising an irregularly-shaped plate-like body defining a somewhat wedge-shaped platform portion 302 and a pivot beam portion 304.

The platform portion 302 may be characterized by a first inclined wall 310 that may transition to a platform member wall 308, in turn transitioning orthogonally to a platform strap wall 306. The platform strap wall 306 may transition orthogonally to a first pivot beam wall 312 in parallel disposition to the platform member wall 308. The pivot beam portion 304 may be characterized by a top wall 314 transitioning from the inclined wall 310. The top wall 314 may be in parallel disposition to the platform strap wall 306. The top wall 314 may transition to a second inclined wall 316, in turn transitioning to an extension outer wall 318. A second pivot beam wall 320 may be parallel to the extension outer wall 318, which together may define a somewhat square columnar pivot bracket extension 305.

The pivot beam portion 304 may comprise a circular pivot beam contact surface 322 for slidable rotation about the pivot beam 276. The pivot beam contact surface 322 may transition from the second pivot beam wall 320 to the first parallel opposed pivot beam wall 312. The semicircular pivot beam contact surface 322 may comprise a somewhat greater diameter than the outside diameter of the pivot beam 276 to facilitate slidable rotation of the platform pivot brackets 296, 298 about the pivot beam 276. The distance separating the pivot beam walls 312, 320 may be equal to the diameter of the pivot beam contact surface 322.

The walls 306, 308, 310, 312, 314, 316, 318, and 320 may each be planar. A circular retainer bore 324 may extend orthogonally through the pivot bracket extension 305 perpendicular to the extension outer wall 318 and the second pivot beam wall 320. A circular retainer seat 326 may extend from the first pivot beam wall 312 into the platform portion 302 coaxial with the retainer bore 324. The retainer seat 326 may be tapped for threadable communication with a threaded pivot beam retainer 300, such as an Allen screw, a hex head bolt, and the like. The retainer bore 324 may be smooth-walled to facilitate insertion and turning of the pivot beam retainer 300 into the retainer seat 326. The pivot beam retainer 300 may be turned into the retainer seat 326 so that the pivot bracket extension 305 may be drawn toward the first pivot beam wall 312, thereby tightening the platform pivot brackets 296, 298 to the pivot beam 276 and reducing the potential for rotation of the platform assembly 236 about the pivot beam 276.

Referring to FIGS. 16 and 17, the platform strap wall 306 may be suitably rigidly coupled, such as by welds 299, with each platform strap 288, 290 so that the platform member wall 308 may contact the proximal platform member 285, and the first pivot beam wall 312 may be aligned with the proximal end 494 of the platform strap 288, 290. The pivot brackets 296, 298 may be rotatably disposed over the pivot beam 276 by inserting the pivot beam 276 into the gap between the first pivot beam wall 312 and the second pivot beam wall 320 until the pivot beam 276 engages the pivot beam contact surface 322. The platform assembly 236 may be rotatably coupled with the pivot beam 276 by threading the pivot beam retainer 300 through the retainer bore 324 into the retainer seat 326.

It may be understood that one or more of the pivot beam retainer 300, the retainer bore 324, and the retainer seat 326, may be adapted so that the retainer 300 may be positioned immediately adjacent the outer surface of the pivot beam 276 when the retainer 300 may be installed in the retainer seat 326, thereby holding the pivot beam 276 against or immediately adjacent the pivot beam contact surface 322. The pivot beam retainer 300 may be installed into the platform pivot bracket 296, 298 so that the pivot bracket may readily rotate about the pivot beam 276, while minimizing movement of the platform portion 302 diametrically toward or away from the pivot beam 276.

As illustrated in FIG. 16, a platform suspension assembly 330 may comprise a pair of tensile connectors 332 coupled with the support frame rail 238 through a first coupling assembly 334, and with the platform assembly 236 through a second coupling assembly 342. Each tensile connector 332 may be characterized as a slender elongate somewhat flexible member, such as a wire rope, steel cable, steel strand, rope fabricated of hemp or polymers, and the like. Each tensile connector 332 may terminate at each end in an end loop, which may be protected by a thimble and ferrule, or other suitable device.

As illustrated in FIG. 13, the first coupling assembly 334 may comprise a threaded fastener 340, characterized herein as a bolt, a plurality of thin circular washers 336, and a threaded nut 338. A through opening, characterized by a diameter somewhat greater than the diameter of the bolt 340, may pass diametrically through the support frame rail 238, parallel to the pivot beam 276. The bolt 340 may be inserted through the coaxial opening of a first washer 336, an end loop of a first tensile connector 332, the coaxial opening of a second washer 336, the through opening of the support frame rail 238, the coaxial opening of a third washer 336, an end loop of a second tensile connector 332, and the coaxial opening of a fourth washer 336, with the nut 338 threaded onto the bolt 340 to hold the first coupling assembly 334 together. It may be recognized that a greater or lesser number of washers 336 may be utilized.

Alternatively, the end loop of each tensile connector 332 may encircle a spool (not shown) on either side of the support frame rail 238 and held by the bolt 340 and the nut 338. The spool may be characterized by an annular center portion, through which the bolt 340 may be inserted, having a length somewhat greater than the diameter, or gauge, of the tensile connector 332. The hollow interior of the annular center portion may be characterized by a diameter somewhat greater than the diameter of the bolt 340.

Each end of the annular center portion may terminate coaxially in an annular flange having a configuration similar to that of the washers 336. Each annular flange may be characterized by a diameter greater than the outside diameter of the annular center portion. The threaded connector 340 may be inserted through a first spool, the through opening of the support frame rail 238, and a second spool, with the nut 338 threaded onto the bolt 340. With the coupling assembly attached to the support frame rail 238, an end loop of each tensile connector 332 may be placed around a spool.

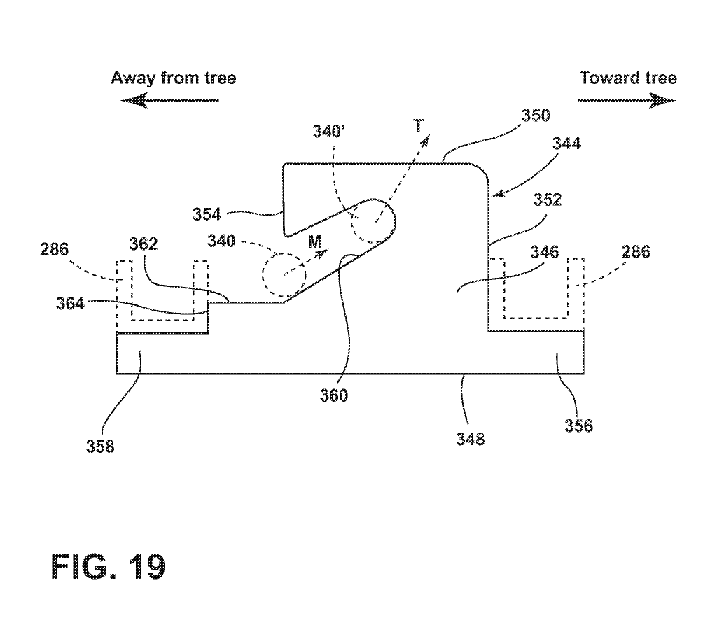

Referring now to FIG. 19, a cable block platform suspension fixture 344 may be characterized as a multi-surfaced unified body comprising a tension block portion 346 and a fixture base portion 348, adapted for operable engagement with the second coupling assembly 342. The cubic tension block portion 346 may be characterized by a planar top wall 350 transitioning orthogonally to a planar proximal wall 352 terminating at the fixture base 348. The terminus of the proximal wall 352 may define a cubic proximal platform member flange 356 extending from the proximal wall 352 to an adjacent end of the fixture base portion 348.

The top wall 350 may also transition orthogonally to a planar distal wall 354, in parallel disposition with the proximal wall 352, and terminating at an inclined slot 360 that may extend into the tension block portion 346. The inclined slot 360 may transition obliquely to a planar alignment wall 362 lying parallel to the top wall 350. The alignment wall 362 may extend from the inclined slot 360 to terminate at a spacing wall 364 depending to the fixture base 348. The terminus of the spacing wall 364 may define a cubic distal platform member flange 358 extending from the spacing wall 364 to an adjacent end of the fixture base portion 348. The height of the proximal platform member flange 356 may be equal to the height of the distal platform member flange 358.

Referring again to FIGS. 10 and 16, the cable block platform suspension fixture 344 may be coupled with the platform assembly 236 by slidably inserting the tension block portion 346 between 2 adjacent platform members 286 so that the proximal platform member flange 356 and the distal platform member flange 358 may be in registry with the undersides of the 2 adjoining platform members 286. As placed, the top wall 350 may face upward when the platform assembly 236 may be coupled with the support frame assembly 232 in preparation for use. In FIG. 19, the platform members 286 are illustrated as phantom section views, with the suspension fixture 344 in orthogonal disposition relative to the platform members 286.

It may be appreciated that the tension block portion 346 may be adapted so that the proximal wall 352 may engage a wall of one platform member 286, and the spacing wall 364 may engage a wall of an adjoining platform member 286. That is to say, the separation of the proximal wall 352 from the spacing wall 364 may be a distance equal to the distance between facing walls of 2 adjacent platform members 286. It may also be appreciated that the platform suspension fixture 344 may be unattached to the platform assembly 236 and thereby may be selectively placed between any two platform members 286, thereby enabling optimization of the rigidity and stability of the platform assembly 236 for different hunters, different tree characteristics, and the like.

Alternatively, the platform suspension fixture 344 may be fixedly coupled with a pair of platform members 286 in a suitable manner, such as by welding, bolted connections, riveted connections, and the like.

The cable block platform suspension fixture 344 may be coupled with the tensile connectors 332 in a manner similar to the connection of the tensile connectors 332 to the support frame rail 238 described above. Essentially, the only difference in the manner of connecting the two tensile connectors 332 to the cable block platform suspension fixture 344 rather than to the support frame rail 238 may be that the second coupling assembly 342 may be assembled separately from the cable block platform suspension fixture 344 prior to attaching the coupling assembly 342 to the suspension fixture 344.

The second coupling assembly 342 may be assembled utilizing the bolt 340, washers 336 or spools, and nut 338, leaving sufficient clearance between the washers 336 or spools to accommodate the width of the platform suspension fixture 344 plus the tensile connectors 332. The loop ends of the tensile connectors 332 may be looped around the bolt 340 between the washers 336, or looped around spools. The bolt 340 may be transversely slidably inserted into the inclined slot 360 (phantom section view of bolt 340) by slidably translating the bolt 340 along the alignment wall 362, and against the closed end of the inclined slot 360 (phantom section view of bolt 3400, represented by the translation vector M. As the platform assembly 236 may be rotated about the pivot beam 276 and lowered into a selected position, the tensile connectors 332 may be placed in tension, represented by the tension vector T, holding the bolt 340 against the closed end of the inclined slot 360.

It may be recognized that a lock nut may be utilized in any above-described assembly in place of a standard nut.

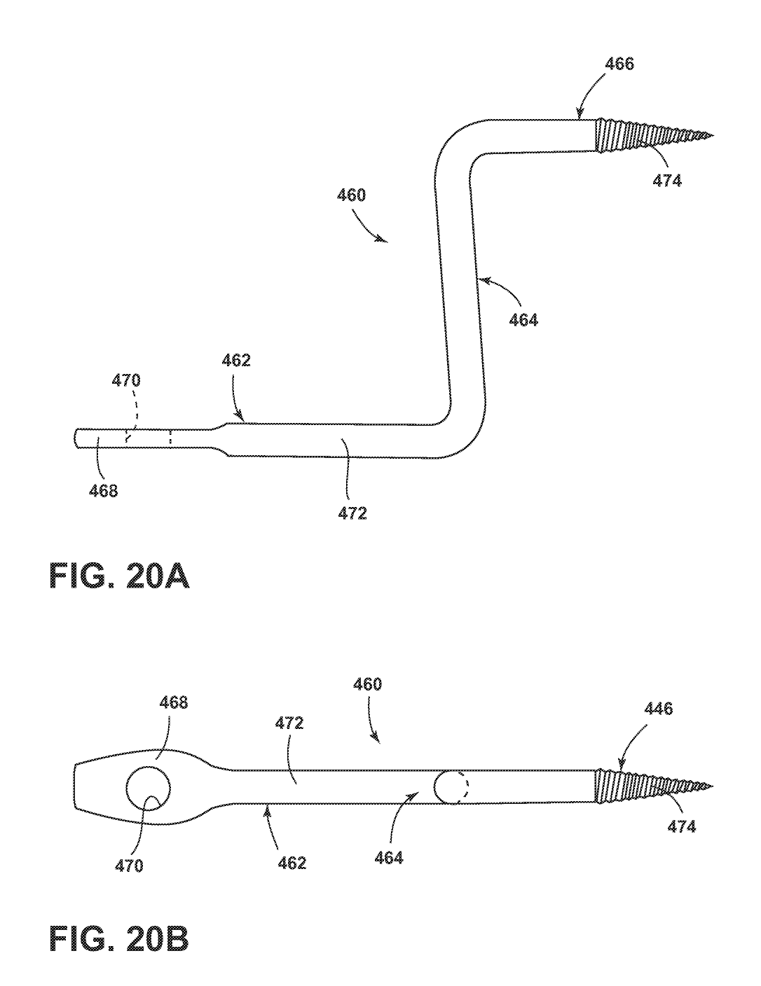

Referring now to FIGS. 20A-B, a threaded climbing anchor 460 may comprise a length of steel or aluminum rod bent into a somewhat S-shaped configuration. The climbing anchor 460 may comprise a distal support portion 462, transitioning generally orthogonally to a connecting portion 464, in turn transitioning generally orthogonally to a proximal embedment portion 466, with the distal support portion 462 and the proximal embedment portion 466 in generally parallel disposition. The distal support portion 462 may terminate in a somewhat flattened locking head 468 comprising a lock opening 470 extending orthogonally through the center of the locking head 468. The locking head 468 may transition to a cylindrical shaft portion 472. The proximal embedment portion 466 may terminate in a threaded end 474 for drilling the climbing anchor 460 into a tree.

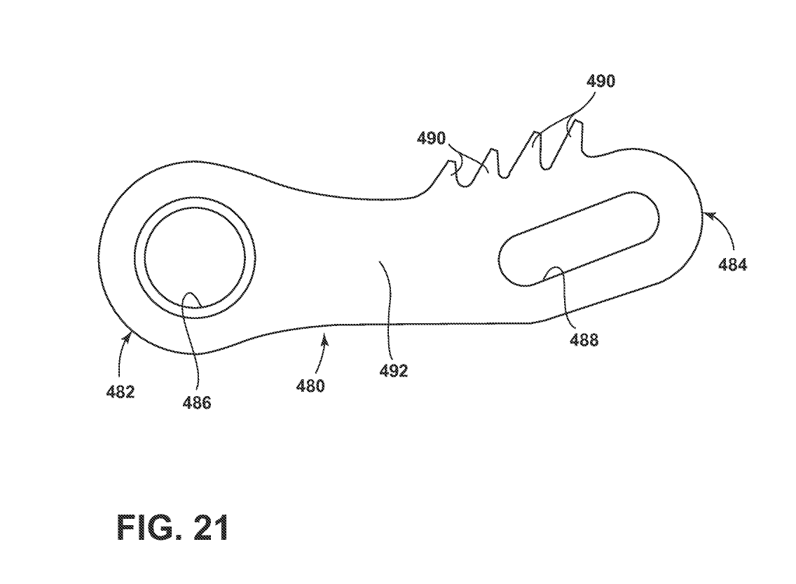

FIG. 21 illustrates an alternative embodiment 480 of the support frame plate 250. The support frame plate 480 may comprise a flattened planar platelike body characterized by a rotation end 482 coupled through a narrow transition portion 492 with an opposed ligature end 484. The rotation end 482 may be characterized by a circular support frame rail opening 486, adapted for slidable engagement with, and translation along, the support frame rail 238. The diameter of the opening 486 may be somewhat greater than the outside diameter of the support frame rail 238, and may be selected to enable slidable movement of the support frame plate 480 along the support frame rail 238, yet minimize “wobble” of the support frame plate 480 relative to the support frame rail 238.

The ligature end 484 may be characterized by an elongated ligature through opening 488 having the general shape of a discorectangle. A longitudinal axis of the through opening 488 may be inclined somewhat acutely relative to an axis extending diametrically through the opening 486 to bisect the transition portion 492. The ligature end 484 may also be characterized by a plurality of outwardly-disposed co-planar frame plate embedment projections 490 adapted for engagement with a tree. It may be recognized that 2 support frame plates 480 may be stacked one upon the other along the support frame rail 238, with the ligature ends 484 spaced apart and the frame plate embedment projections 490 of each support frame plate 480 oriented in the same general direction, i.e. toward a tree. One or more fixably adjustable hanger plate assemblies 240, 241, 242 may be coupled with the support frame rail 238 as described elsewhere herein with respect to the adjustable hanger plate assemblies 240, 242

Each ligature end may be coupled with one of the 2 ligature through openings 488, thereby encircling a tree so that tightening of the attached ligature may urge the frame plate embedment projections 490 against a tree, thereby providing a lightweight effective anchor for the hunting stand 230.

It may be noted that the second embodiment of the tree-mountable hunting stand 230 may be assembled and attached to a tree by one of several different methods, which are described hereinafter. The following exemplary steps may illustrate one method of assembling and attaching the hunting stand 230 to a tree. Other methods may be utilized without limiting the scope of the claims.

Initially, a tree may be scaled in a generally known manner to an elevation at which the hunting stand 230 may be utilized. The threaded climbing anchor 460 may be installed on a tree at an elevation corresponding to the selected elevation of the hunting stand 230. The installation elevation for the climbing anchor 460 may be reached by a known method, such as a ladder, climbing sticks, threaded climbing anchors 460, climbing spikes, and the like. Upon reaching the desired elevation, a climbing anchor 460 may be installed into a tree so that the connecting portion 464 may be in contact with a tree and may depend vertically from the embedment portion 466. The support portion 462 may extend orthogonally away from the connecting portion 464 and generally radially away from a tree. Referring to FIG. 10, with the climbing anchor 460 installed and the shaft portion 472 selectively oriented, the support frame assembly 232 may be brought toward a tree so that the support ring 244 may slidably encircle the support portion 462. The support frame assembly 232 may thus rest upon the support portion 462 until the frame anchor assemblies 246, 248 are attached to the support frame rail 238 and a tree.

The frame anchor assemblies 246, 248 may be attached to a tree with the ligature assemblies 500 as previously described herein, thereby mounting the support frame assembly 232 to a tree. If, for example, the first frame anchor assembly 246 may be fixedly coupled with the support frame rail 238, attachment of the frame anchor assembly 246 to a tree may fixedly attach the support frame rail 238 to a tree. The second frame anchor assembly 248 may be slidably positioned along the support frame rail 238, and attached to a tree with the ligature assembly 500. A fixably adjustable hanger plate assembly 240, 241, 242 may be slidably brought into contact with the upper surface of the second frame anchor assembly 248 and tightened to the support frame rail 238, thereby preventing the support frame rail 238 from dropping through the second frame anchor assembly 248.

Depending upon the use and location of appurtenant accessories, such as frame anchor assemblies 246, 248, fixably adjustable hanger plate assemblies 240, 241, 242, a saddle assembly 234, and the like, the support frame assembly 232 and appurtenant accessories attachable to the support frame rail 238 may be assembled prior to positioning the frame assembly 232 against a tree and engaging the climbing anchor 460. Alternatively, the support frame assembly 232, comprising the support frame rail 238 and attached pivot beam 276, may be lifted to the climbing anchor 460 for insertion of the support portion 462 through the support ring 244, temporarily supporting the support frame assembly 232. This may be followed by the coupling of frame anchor assemblies, hanger plate assemblies, the saddle assembly, and the like, to the support frame rail 238.

Attachment of the support frame assembly 232 to a tree may be followed by coupling of the platform assembly 236 to the pivot beam 276. With reference to FIG. 17, the platform pivot brackets 296, 298 may be slidably coupled with the ends 278, 280 of the pivot beam 276. A pivot beam retainer 300 may be installed in each platform pivot bracket 296, 298 so that the platform assembly 236 may remain pivotably coupled with the pivot beam 276. This may be followed by coupling of the tensile connectors 332 with the support frame rail 238, coupling of the cable block platform suspension fixture 344 with the planar support platform 498, and coupling of the tensile connectors 332 with the cable block platform suspension fixture 344. The platform assembly 236 may be selectively rotated for use into a horizontal position, enabling a hunter to stand on the platform assembly 236. The platform assembly 236 may be selectively rotated when not in use into a vertical position for storage. The saddle assembly 234 may be attached to the support frame assembly 232 by sliding the primary saddle assembly bearing 380 over the support frame rail 238.

With the tree-mountable hunting stand 230 coupled with a tree, a hunter may stand on the platform assembly 236, selectively straddling the straddle portion 406. A hunter may alternate between a fully standing position, a partially supported position including engagement with the saddle support portion 404, and a weight-forward position including engagement of the hunter's abdomen with the pommel portion 402.

When a hunter has finished hunting for the day, the saddle 400 may be removed from the saddle bearing assembly 372, the tensile connectors 332 may be removed, and the platform assembly 236 may be rotated to a vertical orientation, enabling removal of the pivot beam retainers 300, and removal of the platform assembly 236 from the pivot beam 276. This may enable the saddle 400 and the platform assembly 236 to be taken with a hunter. With reference to FIG. 10, a locking apparatus 512, such as a padlock, may be coupled with the lock opening 470 in the locking head 468 to prevent separation of the support ring 244 from the distal support portion 462 of the installed climbing anchor 460, thereby preventing unauthorized removal of the support frame assembly 232 from a tree. Alternatively, the locking apparatus 512 may be concurrently coupled with both the lock opening 470 and the support ring 244 to provide additional impediments to removal of the support frame assembly 232.

The modular tree-mountable hunting stand 230 may be utilized without the modular saddle assembly 234, with a hunter merely standing or sitting upon the modular platform assembly 236. Alternatively, the modular platform assembly 236 may be removed from the pivot beam 276 by first removing the pivot beam retainers 300 from the platform pivot brackets 296, 298 so that the modular platform assembly 236 may be removed from the pivot beam 276. The modular platform assembly 236 may then be replaced with a platform assembly having a different shape, different dimensions, a different structure, or different functionalities.

Alternatively, the modular tree-mountable hunting stand 230 may be attached to a tree, as generally described above, at or near the base rather than an elevated location, so that a hunter may straddle the straddle portion 406 of the saddle 400. This may enable a hunter to stand upon the ground, utilizing the pommel portion 402, saddle support portion 404, and straddle portion 406, as hereinbefore described, to pivot about the pivot arm rotational axis 478 and/or the saddle rotational axis 408.

The modular nature of the tree-mountable hunting stand 230 allows for a high degree of flexibility in adapting the hunting stand to various users and conditions. The hunting stand may be securely anchored to a tree using one or more frame anchor assemblies that can be slidably positioned along the support frame rail and secured through a system of embedment projections, strap assemblies, and strap tensioners. Fixably adjustable hanger plate assemblies can be utilized to support accessories from the support frame rail. Raising and lowering the hanger plate assemblies to position the accessories for optimal accessibility can be readily performed. This can be particularly advantageous with respect to the positioning of the saddle.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention, which is defined in the appended claims.

1. A modular hunting stand comprising:
a modular support frame assembly attachable to a tree, comprising
a support frame rail characterized by a central longitudinal axis,
a support frame plate characterized by an embedment projection, and a circular opening extending therethrough for slidable coupling with the support frame rail, and
a hanger plate characterized by a circular opening extending therethrough for fixable coupling with the support frame rail; and
a modular saddle assembly attachable to the modular support frame assembly, comprising
a saddle characterized by a pommel portion coupled with a saddle support portion through a straddle portion,
a saddle bearing assembly coupled with the saddle, and characterized by a first axis of rotation,
a support frame bearing assembly characterized by a second axis of rotation collinear with the central longitudinal axis, and
a pivot arm assembly rigidly coupled at a distal end with the saddle bearing assembly and at a proximal end with the support frame bearing assembly;
wherein the modular saddle assembly is movable by a hunter straddling the straddle portion while standing upright; and
wherein the saddle is adapted so that a hunter, while straddling the straddle portion, can adopt
a) an unsupported standing position, or
b) a partially supported standing position wherein the saddle support portion is engageable by a hunter to partially support a hunter's weight, or
c) a weight-forward standing position wherein the pommel portion is engageable by a hunter's abdomen to augment a hunter's balance.

2. A modular hunting stand in accordance with claim 22, and further comprising a platform pivot bracket fixedly coupled with the planar support platform and pivotably coupleable with the pivot beam.

3. A modular hunting stand in accordance with claim 1 wherein the first axis of rotation is parallel with the second axis of rotation, and the modular saddle assembly is rotatable about the second axis of rotation.

4. A modular hunting stand in accordance with claim 3 wherein the saddle and the saddle assembly are independently rotatable about the first and second axes of rotation.

5. A modular hunting stand in accordance with claim 22, and further comprising a cable block platform suspension fixture, including a tensile connector attachable to the cable block platform suspension fixture and to the support frame assembly.

6. A modular hunting stand in accordance with claim 5, and further comprising a flanged coupling assembly for removably attaching the cable block platform suspension fixture to the tensile connector.

7. A modular hunting stand in accordance with claim 6 wherein the tensile connector is attachable to the cable block platform suspension fixture through a first flanged coupling assembly, and to the modular support frame assembly through a second flanged coupling assembly.

8. A modular hunting stand in accordance with claim 1 wherein, in a first disposition, the support frame plate is slidable along the support frame rail, and in a second disposition, the support frame plate is immobilized relative to the support frame rail.

9. A modular hunting stand in accordance with claim 8 wherein the first disposition is characterized in that the embedment projection does not extend from the support frame plate into a tree, and the second disposition is characterized in that the embedment projection extends from the support frame plate into a tree.

10. A modular hunting stand in accordance with claim 1 wherein, in a first disposition, the hanger plate is slidable along the support frame rail, and in a second disposition, the hanger plate is immovable relative to the support frame rail.

11. A modular hunting stand in accordance with claim 10 wherein the hanger plate circular opening transitions radially to a compression gap intersecting a perimeter of the hanger plate.

12. A modular hunting stand in accordance with claim 11, and further comprising a hanger plate tightener for selectively widening and narrowing the compression gap.

13. A modular hunting stand in accordance with claim 12 wherein the first disposition is characterized in that the hanger plate tightener does not narrow the compression gap, and the second disposition is characterized in that the hanger plate tightener selectively narrows the compression gap.

14. A modular hunting stand in accordance with claim 1 wherein the support frame rail is a circular tube.

15. A modular hunting stand in accordance with claim 1 wherein the modular support frame assembly, the modular platform assembly, and the modular saddle assembly are suspendible from the support frame plate when the embedment projection extends from the hanger plate into a tree, and the hanger plate is immovable relative to the support frame rail and sits upon the support frame plate.

16. A modular hunting stand in accordance with claim 15 wherein the support frame rail is selectively moveable through the support frame plate circular opening to change an elevation of one of the modular platform assembly and the modular saddle assembly.

17. A modular hunting stand in accordance with claim 1, and further comprising a ligature characterized by two ligature ends, wherein each ligature end is coupleable to the support frame plate to encircle a tree and attach the support frame plate at a selected elevation.

18. A modular hunting stand in accordance with claim 1 wherein the modular platform assembly comprises an open-frame platform assembly pivotally coupleable with the pivot beam for selective rotation of the open-frame platform assembly between a first orientation, and a second orientation perpendicular to the first orientation.

19. A modular hunting stand in accordance with claim 1 wherein, while the support frame assembly is attached to a tree, the hanger plate is fixedly attachable to, or slidably removable along, the support frame rail to reposition the hanger plate assembly on the support frame rail.

20. A modular hunting stand in accordance with claim 1 wherein, when the support frame assembly is attached to a tree, the location of the hanger plate is adjustable along the support frame rail without disattachment of the support frame assembly from a tree.

21. A modular hunting stand in accordance with claim 1 wherein the straddle portion is characterized by a triangular cross-section.

22. A modular hunting stand comprising:
a modular support frame assembly attachable to a tree, comprising
a support frame rail characterized by a central longitudinal axis,
a pivot beam orthogonally coupled with the support frame rail,
a support frame plate characterized by an embedment projection, and a circular opening extending therethrough for slidable coupling with the support frame rail, and
a hanger plate characterized by a circular opening extending therethrough for fixable coupling with the support frame rail;
a modular platform assembly pivotably attachable to the modular support frame assembly, comprising
a planar support platform pivotably coupleable with the pivot beam; and
a modular saddle assembly attachable to the modular support frame assembly, comprising
a saddle characterized by a pommel portion coupled with a saddle support portion through a straddle portion,
a saddle bearing assembly coupled with the saddle, and characterized by a first axis of rotation,
a support frame bearing assembly characterized by a second axis of rotation collinear with the central longitudinal axis, and
a pivot arm assembly rigidly coupled at a distal end with the saddle bearing assembly and at a proximal end with the support frame bearing assembly;
wherein the first and second axes of rotation are parallel vertical rotation axes and the saddle is rotatable about the first axis of rotation independent of rotation about the second axis of rotation.

23. A modular hunting stand, comprising:
a support frame assembly attachable to a tree, comprising
a support frame rail characterized by a central longitudinal axis,
a support frame plate characterized by an embedment projection, and a circular opening extending therethrough for slidable coupling with the support frame rail, and
a hanger plate characterized by a circular opening extending therethrough for fixable coupling with the support frame rail; and
a seat assembly coupleable with the support frame assembly, comprising
a seat,
a seat bearing assembly coupled with the seat, and characterized by a first axis of rotation around which the seat is rotatable,
a support frame bearing assembly characterized by a second axis of rotation collinear with the central longitudinal axis, and
a pivot arm assembly rigidly coupled at a distal end with the seat bearing assembly and at a proximal end with the support frame bearing assembly;
wherein the central longitudinal axis is parallel with the first axis of rotation and the second axis of rotation;
wherein, when the seat assembly is coupled with the support frame assembly, the first axis of rotation is parallel with the second axis of rotation, and the seat is rotatable about the first axis of rotation and the second axis of rotation; and
wherein, when the seat assembly is coupled with the support frame assembly, the seat and the pivot arm assembly are independently rotatable about the first axis of rotation and the second axis of rotation, respectively.

24. A modular hunting stand in accordance with claim 23, further comprising a platform assembly pivotably attachable to the support frame assembly and comprising a support platform.

25. A modular hunting stand in accordance with claim 24, and further comprising a pivot beam orthogonally coupled with the support frame rail, wherein the support platform is pivotally couplable with the pivot beam for selective rotation of the support platform between a first orientation, and a second orientation perpendicular to the first orientation.

26. A modular hunting stand comprising:
a support frame vertically attachable to a tree, the support frame including a vertical support member characterized by a central longitudinal axis and at least one support frame member immovably couplable with the vertical support member;
a support frame plate characterized by an embedment projection, and a circular opening extending therethrough for slidable coupling with the vertical support member;
at least one hanger plate characterized by a circular opening extending therethrough for fixable coupling with the vertical support member;
a saddle characterized by a pommel portion coupled with a saddle support portion through a straddle portion;
a saddle bearing assembly coupled with the saddle, characterized by a first axis of rotation;
a support frame bearing assembly characterized by a second axis of rotation collinear with the central longitudinal axis; and
a pivot arm assembly coupling the saddle bearing assembly with the support frame bearing assembly;
wherein the first axis of rotation is parallel with the second axis of rotation, and the saddle is rotatable about the first axis of rotation and the second axis of rotation;
wherein the saddle and the pivot arm assembly are independently rotatable about the first axis of rotation and the second axis of rotation, respectively.

27. A modular hunting stand in accordance with claim 26 wherein the pommel portion is engageable by a hunter's abdomen to augment a hunters' balance while straddling the straddle portion.

28. A modular hunting stand in accordance with claim 26 wherein the saddle support portion is engageable by a hunter straddling the straddle portion to partially support a hunter's weight.
